(19) United States
(12) Patent Application Publication
(10) Pub. No.: US 2025/0379253 A1
(43) Pub. Date: Dec. 11, 2025

(54) ELECTROLYTE AND ELECTROCHEMICAL APPARATUS

(71) Applicant: Ningde Amperex Technology Limited, Ningde (CN)

(72) Inventors: Xiexue PENG, Ningde (CN); Junhua JIAN, Ningde (CN); Junfei LIU, Ningde (CN); Chao TANG, Ningde (CN)

(73) Assignee: Ningde Amperex Technology Limited, Ningde (CN)

(21) Appl. No.: 19/302,393

(22) Filed: Aug. 18, 2025

Related U.S. Application Data
(63) Continuation of application No. PCT/CN2023/076752, filed on Feb. 17, 2023.

(51) Int. Cl. H01M 10/0567; H01M 10/0525; H01M 10/0568

(52) U.S. Cl. CPC H01M 10/0567; H01M 10/0525; H01M 10/0568; H01M 2300/0025

(57) ABSTRACT

An electrolyte including a compound of Formula I-A, a compound of Formula I-B, and a compound of Formula I-C:

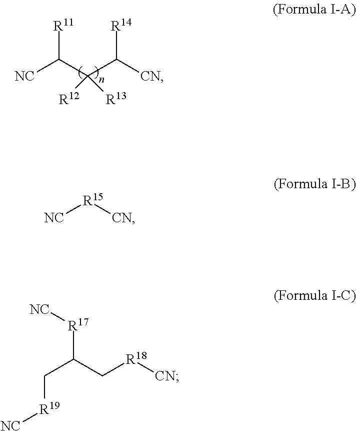

where based on a mass of the electrolyte, a percentage of the compound of Formula I-A ranges from 0.12% to 5.0%; a percentage of the compound of Formula I-B ranges from 0.12% to 5.0%; and a percentage of the compound of Formula I-C ranges from 0.12% to 3.0%.

### CROSS REFERENCE TO THE RELATED APPLICATIONS

This application is a continuation under 35 U.S.C. § 120 of international patent application PCT/CN2023/076752 filed on Feb. 17, 2023, the entire content of which is incorporated herein by reference.

### TECHNICAL FIELD

This application relates to the field of energy storage, and specifically, to an electrolyte and an electrochemical apparatus.

### BACKGROUND

With the widespread application of electrochemical apparatuses (such as lithium-ion batteries) in various electronic products, users have increasingly higher requirements for the performance of electrochemical apparatuses, particularly focusing on long cycle life and self-discharge rate. The lifespan of an electrochemical apparatus is affected by impedance growth during cycling, and the voltage drop of the electrochemical apparatus during high-temperature storage reflects its self-discharge condition.

Factors influencing impedance growth during cycling and voltage drop during high-temperature storage of an electrochemical apparatus include the stability between an active material interface and an electrolyte interface. Poor interface stability leads to continuous electrolyte decomposition. Improving the stability between the active material interface and the electrolyte interface to suppress electrolyte decomposition has become one of the urgent issues to be addressed.

In view of this, it is necessary to provide an electrolyte and an electrochemical apparatus capable of offering improved cycling performance and high-temperature storage performance.

### SUMMARY

This application provides an electrolyte and an electrochemical apparatus to attempt to address, at least to some extent, at least one problem existing in the related art.

According to a first aspect of this application, this application provides an electrolyte including a compound of Formula I-A, a compound of Formula I-B, and a compound of Formula I-C:

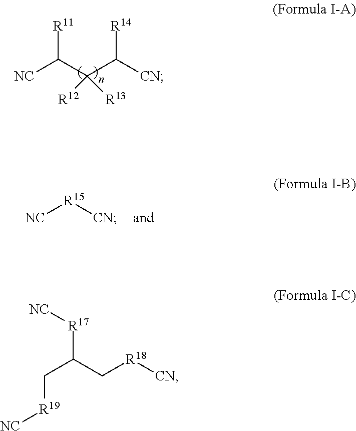

where
n is an integer selected from 1 to 8;
R¹¹, R¹², R¹³, and R¹⁴ are each independently selected from hydrogen, halogen, or a substituted or unsubstituted C₁-C₅ alkyl group, and at least one of R¹¹, R¹², R¹³, or R¹⁴ is a substituted or unsubstituted C₁-C₅ alkyl group;
R¹⁵ is selected from a C₂-C₄ alkylene group, a C₂-C₄ alkenylene group,

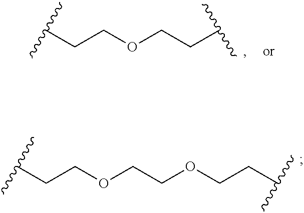 [SMILES: *CCOCC* ; *CCOCCOCC*]

R¹⁷, R¹⁸, and R¹⁹ are each independently selected from a single bond, a C₁-C₅ alkylene group, or a C₁-C₅ alkoxyalkylene group;
when substitution is performed, substituents are each independently halogen;

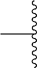

represents a connection site of two adjacent atoms; and
based on a mass of the electrolyte,
a percentage of the compound of Formula I-A is X %, with X ranging from 0.12 to 5.0,
a percentage of the compound of Formula I-B is Y %, with Y ranging from 0.12 to 5.0, and
a percentage of the compound of Formula I-C is Z %, with Z ranging from 0.12 to 3.0.

The compound of Formula I-A, the compound of Formula I-B, and the compound of Formula I-C are all polynitrile compounds. The presence of multiple cyano groups can stabilize a positive electrode active material (for example, transition metals in the positive electrode active material). The compound of Formula I-A has branched chains, which increases steric hindrance, improves protection for a positive electrode interface, but results in higher viscosity. The compound of Formula I-B has lower viscosity. The compound of Formula I-C provides strong stability to the positive electrode active material. The electrolyte including specific percentages of the compound of Formula I-A, the compound of Formula I-B, and the compound of Formula I-C can effectively improve the cycling performance and high-temperature storage performance of an electrochemical apparatus containing the electrolyte.

According to an embodiment of this application, X ranges from 0.5 to 4.2; Y ranges from 0.5 to 4.2; and Z ranges from 0.5 to 3.0.

According to an embodiment of this application, Z/X ranges from 0.1 to 3.

According to an embodiment of this application, Z/X ranges from 0.6 to 2.5.

According to an embodiment of this application, the compound of Formula I-A includes at least one of the following compounds:

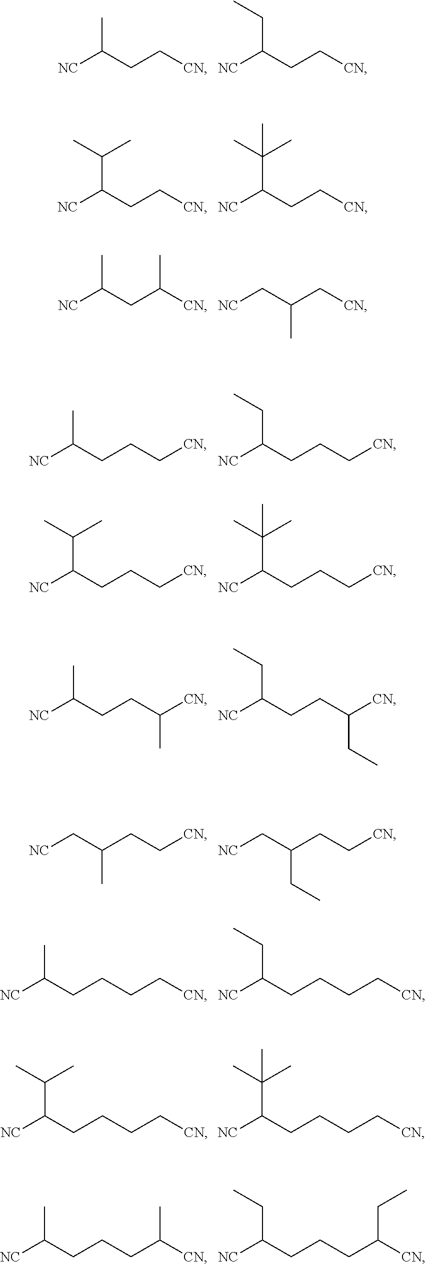

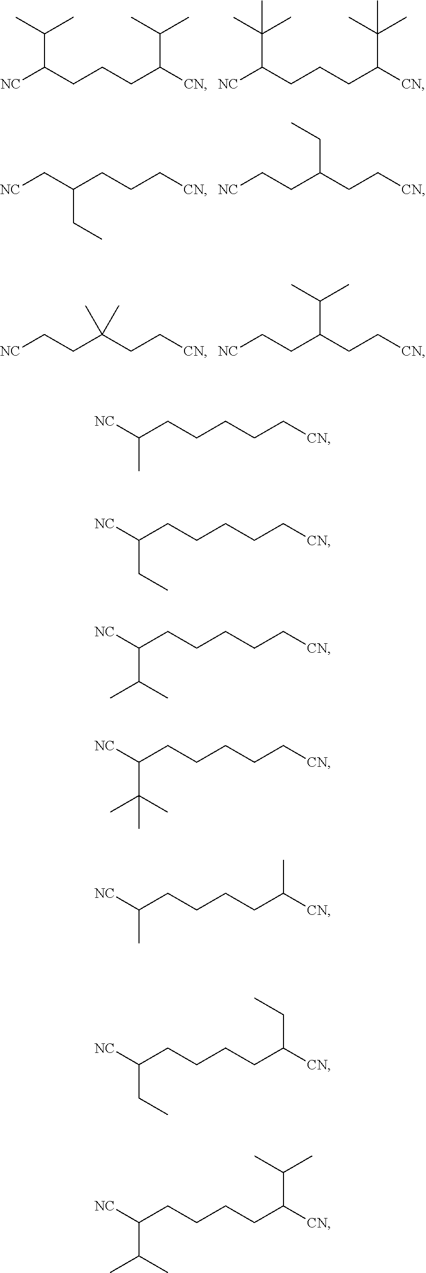

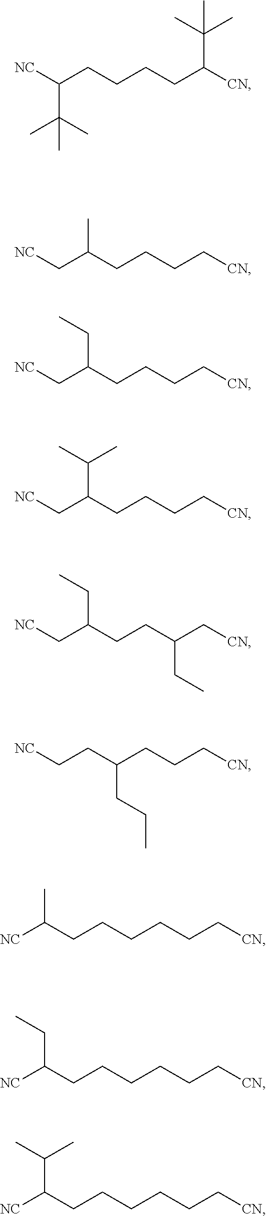

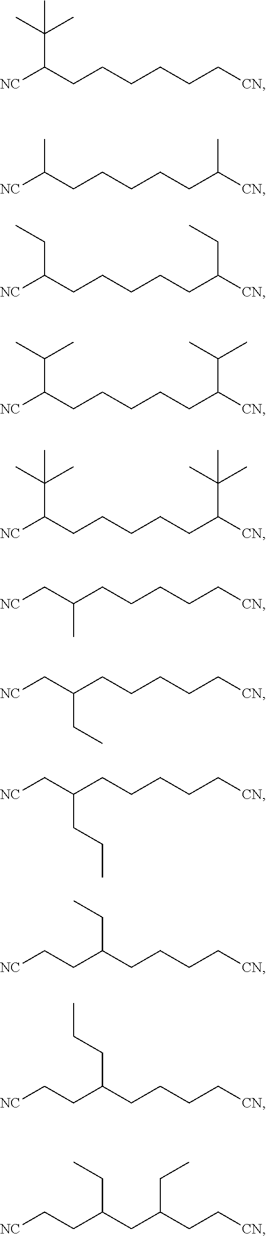

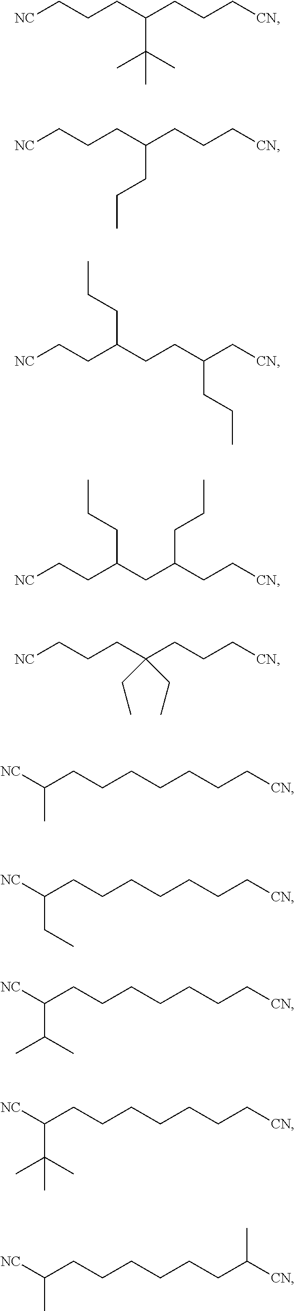

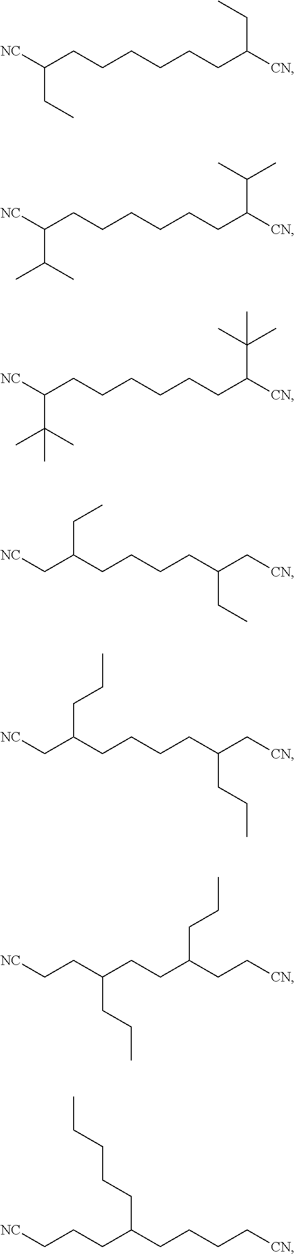

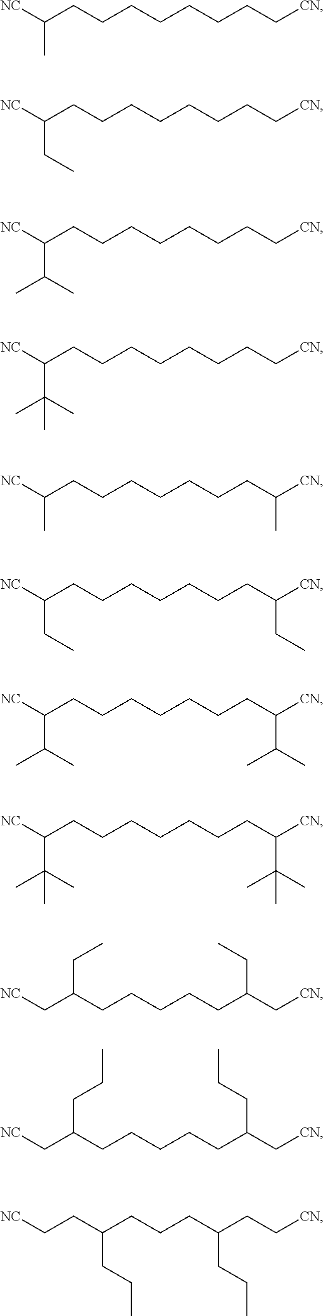

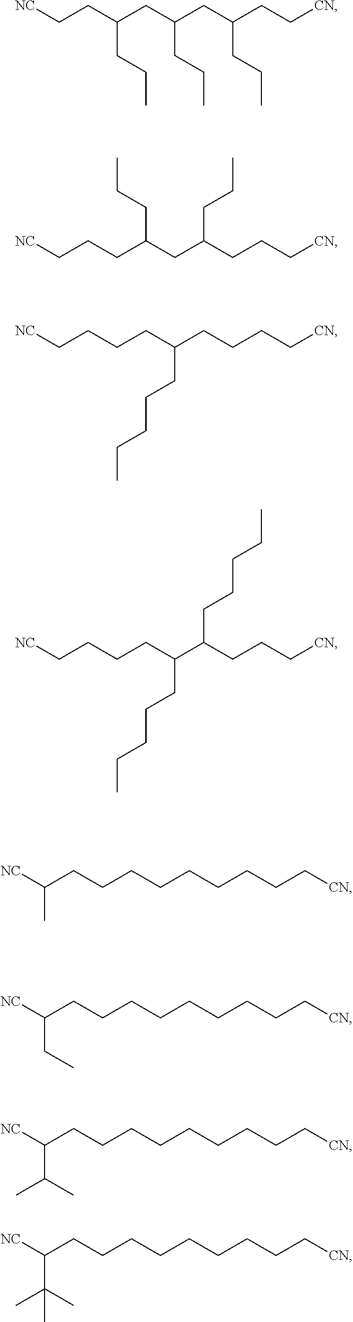

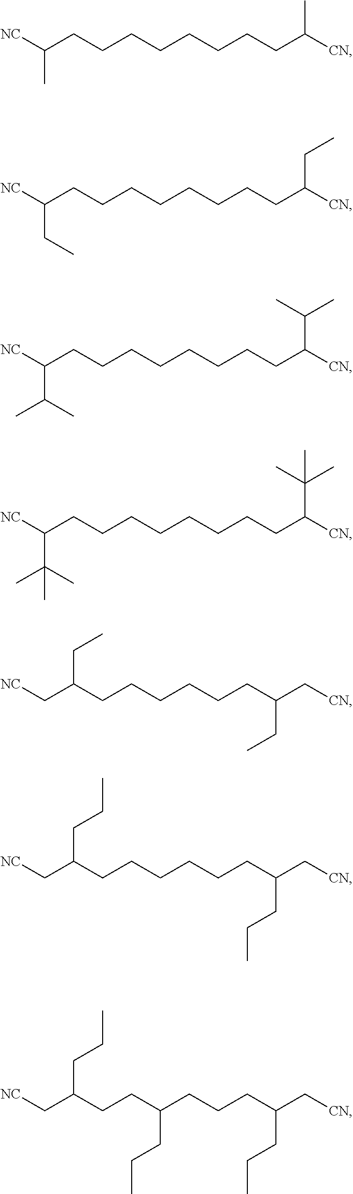

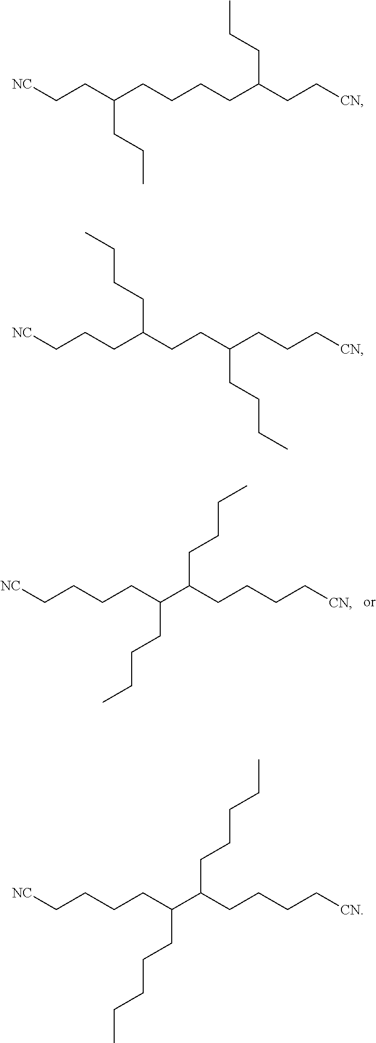 [SMILES: CCCC(CCC#N)CCCCC(CCC)CCC#N ; CCCCC(CCCC#N)CCC(CCCC)CCCC#N ; CCCCC(CCCCC#N)C(CCCC)CCCCC#N ; CCCCCC(CCCCC#N)C(CCCCC)CCCCC#N]

According to an embodiment of this application, the compound of Formula I-B includes at least one of the following compounds:

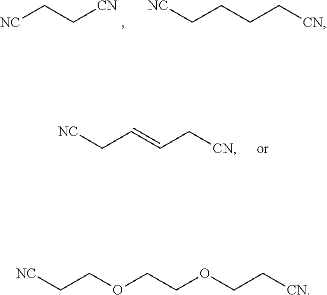 [SMILES: N#CCCC#N ; N#CCCCCC#N ; "," ; N#CC/C=C/CC#N ; N#CCCOCCOCCC#N]

According to an embodiment of this application, the compound of Formula I-C includes at least one of the following compounds:

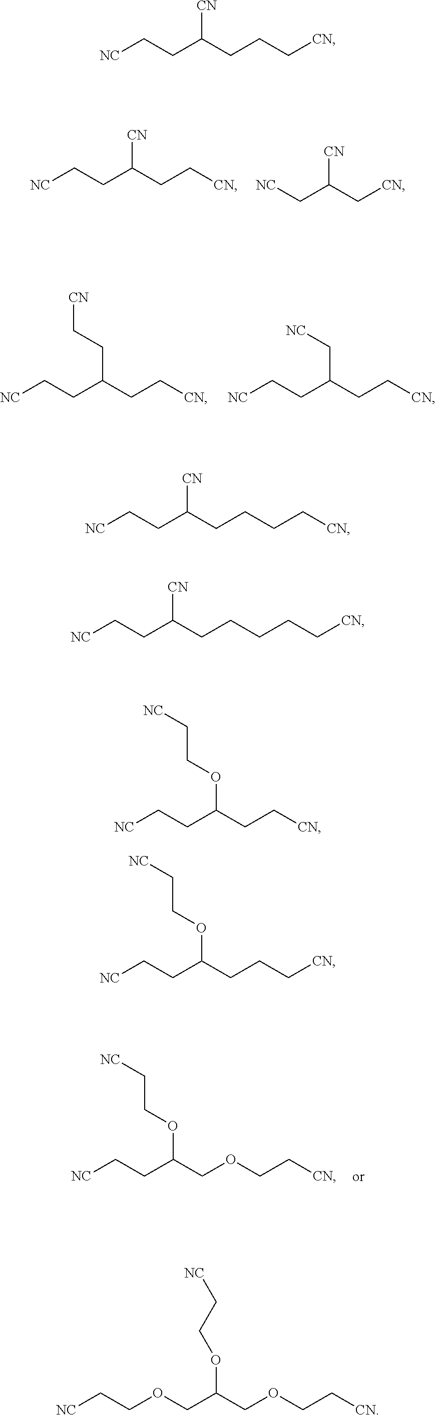

According to an embodiment of this application, Y/X ranges from 0.12 to 5.

According to an embodiment of this application, the electrolyte further includes a compound containing a sulfur-oxygen double bond, and based on the mass of the electrolyte, a percentage of the compound containing a sulfur-oxygen double bond ranges from 0.01% to 10%.

According to an embodiment of this application, the compound containing a sulfur-oxygen double bond includes a compound of Formula II:

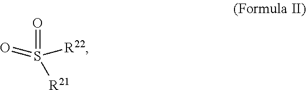

where
R²¹ and R²² are each independently selected from a substituted or unsubstituted C₁-C₅ alkyl group, a substituted or unsubstituted C₂-C₁₀ alkenyl group, a substituted or unsubstituted C₂-C₁₀ alkynyl group, a substituted or unsubstituted C₃-C₁₀ alicyclic group, a substituted or unsubstituted C₆-C₁₀ aryl group, or a substituted or unsubstituted C₁-C₅ heteroatom functional group, with a heteroatom in the heteroatom functional group selected from at least one of O or S;
R²¹ and R²² are optionally connected to form a ring; and
when substitution is performed, substituents are each independently selected from halogen.

According to an embodiment of this application, the compound containing a sulfur-oxygen double bond includes at least one of the following compounds:

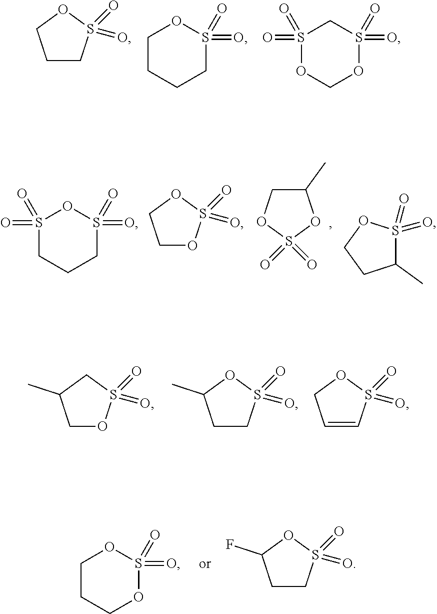

When the electrolyte further includes a specified percentage of the compound containing a sulfur-oxygen double bond, the stability of a positive electrode interface and a negative electrode interface can be effectively improved without significantly affecting the viscosity of the electrolyte or the impedance of the positive electrode interface and the negative electrode interface, further improving the cycling performance and high-temperature storage performance of the electrochemical apparatus.

According to an embodiment of this application, the electrolyte further includes a compound of Formula III:

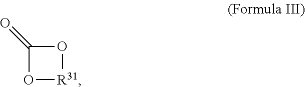

where
R³¹ is selected from a substituted or unsubstituted C₁-C₆ alkylene group or a substituted or unsubstituted C₂-C₆ alkenylene group;
when substitution is performed, substituents are each independently selected from halogen, a C₁-C₆ alkyl group, or a C₂-C₆ alkenyl group; and
based on the mass of the electrolyte, a percentage of the compound of Formula III ranges from 0.01% to 15%.

According to an embodiment of this application, the compound of Formula III includes at least one of the following compounds:

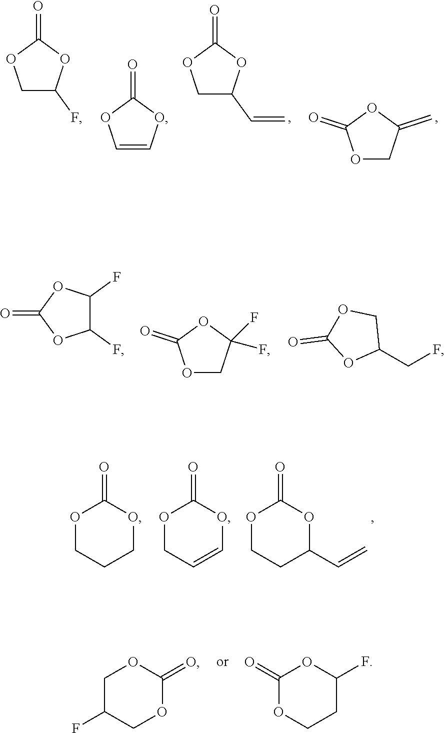

When the electrolyte further includes a specified percentage of the compound of Formula III, the negative electrode interface can be adequately protected, further improving the cycling performance and high-temperature storage performance of the electrochemical apparatus.

According to an embodiment of this application, the electrolyte further includes a compound IV, and the compound IV includes at least one of the following compounds:

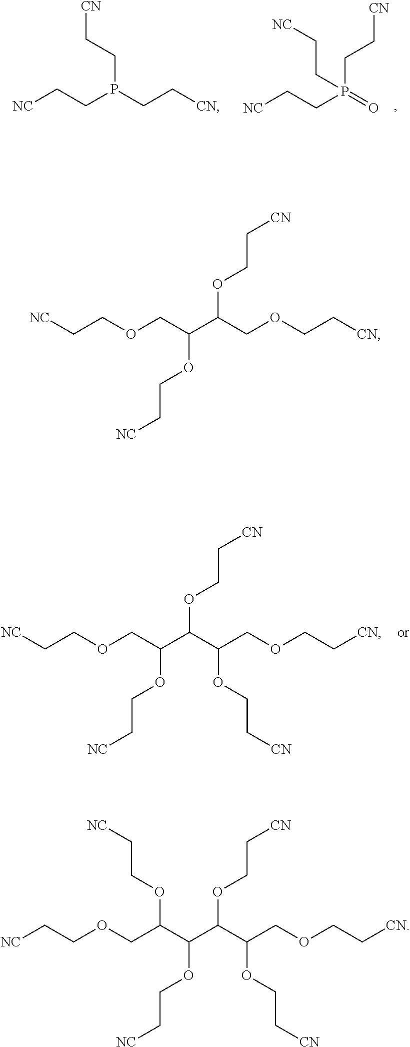 [SMILES: N#CCCP(CCC#N)CCC#N ; N#CCCP(=O)(CCC#N)CCC#N ; N#CCCOCC(OCCC#N)C(COCCC#N)OCCC#N ; N#CCCOCC(OCCC#N)C(OCCC#N)C(COCCC#N)OCCC#N ; N#CCCOCC(OCCC#N)C(OCCC#N)C(OCCC#N)C(COCCC#N)OCCC#N]

According to an embodiment of this application, based on the mass of the electrolyte, a percentage of the compound IV ranges from 0.01% to 2%.

When the electrolyte further includes a specified percentage of the compound IV, electrolyte decomposition can be further suppressed, reducing the cycling impedance growth and high-temperature storage thickness swelling rate of the electrochemical apparatus, thereby significantly improving the cycling performance and high-temperature storage performance of the electrochemical apparatus.

According to an embodiment of this application, the electrolyte further includes a boron-containing lithium salt, and based on the mass of the electrolyte, a percentage of the boron-containing lithium salt ranges from 0.01% to 1%.

According to an embodiment of this application, the boron-containing lithium salt includes at least one of lithium tetrafluoroborate, lithium bis(oxalate)borate, or lithium difluoro(oxalate)borate.

According to an embodiment of this application, based on the mass of the electrolyte, the percentage of the boron-containing lithium salt is M %, and M/X is not greater than 1.

When the electrolyte further includes a specified percentage of the boron-containing lithium salt, the cycling impedance growth of the electrochemical apparatus can be further reduced, further significantly improving the cycling performance of the electrochemical apparatus.

According to another aspect of this application, this application provides an electrochemical apparatus including a positive electrode, a negative electrode, and the electrolyte according to this application.

According to still another aspect of this application, this application provides an electronic apparatus including the electrochemical apparatus according to this application.

This application provides an electrolyte, an electrochemical apparatus, and an electronic apparatus. When the electrolyte includes specific percentages of the compound of Formula I-A, the compound of Formula I-B, and the compound of Formula I-C, the electrolyte has an appropriate viscosity, stabilizes the positive electrode active material, protects the positive electrode interface, and suppresses electrolyte decomposition, thereby significantly reducing the cycling impedance growth and high-temperature storage voltage drop of the electrochemical apparatus. This significantly improves the cycling performance and high-temperature storage performance of the electrochemical apparatus while achieving a lower viscosity electrolyte, improving the kinetic performance of the electrochemical apparatus.

Additional aspects and advantages of this application will be partially described, shown, or explained through the implementation of some embodiments of this application.

### DETAILED DESCRIPTION

Some embodiments of this application will be described in detail below. These embodiments of this application should not be construed as limiting this application.

In specific embodiments and claims, a list of items connected by the term “at least one of” may mean any combination of the listed items. For example, if items A and B are listed, the phrase “at least one of A and B” means only A; only B; or A and B. In another example, if items A, B, and C are listed, the phrase “at least one of A, B, and C” means only A; only B; only C; A and B (excluding C); A and C (excluding B); B and C (excluding A); or all of A, B, and C. Item A may include a single element or a plurality of elements. Item B may include a single element or a plurality of elements. Item C may include a single element or a plurality of elements.

The term “alkyl group” refers to a straight-chain saturated hydrocarbon structure having 1 to 20 carbon atoms. The term “alkyl group” is also intended to refer to a branched or cyclic hydrocarbon structure having 3 to 20 carbon atoms. References to an alkyl group with a specific carbon number are intended to cover all geometric isomers with the specific carbon number. Therefore, for example, “butyl group” includes an n-butyl group, a sec-butyl group, an isobutyl group, a tert-butyl group, and a cyclobutyl group; and “propyl group” includes an n-propyl group, an isopropyl group, and a cyclopropyl group. Examples of the alkyl group include but are not limited to a methyl group, an ethyl group, an n-propyl group, an isopropyl group, a cyclopropyl group, an n-butyl group, an isobutyl group, a sec-butyl group, a tert-butyl group, a cyclobutyl group, an n-pentyl group, an isopentyl group, a neopentyl group, a cyclopentyl group, a methylcyclopentyl group, an ethylcyclopentyl group, an n-hexyl group, an isohexyl group, a cyclohexyl group, an n-heptyl group, an octyl group, a cyclopropyl group, a cyclobutyl group, a norbornyl group, and the like.

The term “alkenyl group” refers to a straight-chain or branched monovalent unsaturated hydrocarbon group having at least one and typically 1, 2, or 3 carbon-carbon double bonds. Unless otherwise defined, the alkenyl group generally contains 2 to 20 carbon atoms and includes (for example) a —C₂₋₄ alkenyl group, a —C₂₋₆ alkenyl group, and a —C₂₋₁₀ alkenyl group. Representative alkenyl groups include (for example) a vinyl group, an n-propenyl group, an isopropenyl group, an n-but-2-enyl group, a but-3-enyl group, and an n-hex-3-enyl group.

The term “alkynyl group” refers to a straight-chain or branched monovalent unsaturated hydrocarbon group having at least one and typically 1, 2, or 3 carbon-carbon triple bonds. Unless otherwise defined, the alkynyl group generally contains 2 to 20 carbon atoms and includes (for example) a —C₂₋₄ alkynyl group, a —C₃₋₆ alkynyl group, and a —C₃₋₁₀ alkynyl group. Representative alkynyl groups include (for example) an ethynyl group, a prop-2-ynyl group (an n-propynyl group), an n-but-2-ynyl group, and an n-hex-3-ynyl group.

The term “alkylene group” covers straight-chain and branched alkylene groups. For example, the alkylene group may be a C₁-C₅₀ alkylene group, a C₁-C₄₀ alkylene group, a C₁-C₃₀ alkylene group, a C₁-C₂₀ alkylene group, a C₁-C₁₀ alkylene group, a C₁-C₆ alkylene group, a C₂-C₆ alkylene group, or a C₂-C₅ alkylene group.

The term “alkenylene group” covers straight-chain and branched alkenylene groups. For example, the alkenylene group may be a C₂-C₅₀ alkenylene group, a C₂-C₄₀ alkenylene group, a C₂-C₃₀ alkenylene group, a C₂-C₂₀ alkenylene group, a C₂-C₁₀ alkenylene group, a C₁-C₆ alkenylene group, or a C₂-C₆ alkenylene group.

The term “aryl group” refers to a monovalent aromatic hydrocarbon having a monocyclic (for example, a phenyl group) or fused ring. A fused ring system includes fully unsaturated ring systems (for example, naphthalene) and partially unsaturated ring systems (for example, 1,2,3,4-tetrahydronaphthalene). Unless otherwise defined, the aryl group generally contains 6 to 26 carbon ring atoms and includes (for example) a —C₆₋₁₀ aryl group. Representative aryl groups include (for example) a phenyl group, a methylphenyl group, a propylphenyl group, an isopropylphenyl group, a benzyl group, a naphth-1-yl group, and a naphth-2-yl group.

The term “halogen” may be F, Cl, Br, or I.

The term “heteroatom” encompasses O, S, P, N, B, or their electronic isosteres.

The term “heteroatom functional group” refers to a functional group containing a heteroatom, where the heteroatom includes at least one of O, S, P, N, or B. Examples of the heteroatom functional group include but are not limited to a C₀-C₅ sulfonate group, a C₀-C₅ sulfate group, a C₀-C₅ ether group, a C₀-C₅ sulfinate group, a C₀-C₅ sulfite group, a C₀-C₅ phosphate group, and a C₀-C₅ borate group.

The term “alicyclic group” refers to a saturated, partially unsaturated, or unsaturated mono-, di-, tri-, or polycyclic group having approximately 3 to 15 carbon atoms, or 3 to 12 carbon atoms, or 3 to 8 carbon atoms, or 3 to 6 carbon atoms, or 5 or 6 carbon atoms. Examples of the alicyclic group include but are not limited to a cyclopropyl group, a cyclobutyl group, a cyclobutenyl group, a cyclopentyl group, a cyclopentenyl group, a cyclohexyl group, a cyclohexenyl group, a cycloheptyl group, and a cyclooctyl group.

With the widespread application of electrochemical apparatuses (for example, lithium-ion batteries), increasingly high requirements are imposed on the performance of electrochemical apparatuses. The primary method for increasing the energy density of an electrochemical apparatus includes raising the charging voltage of the electrochemical apparatus. However, when the charging voltage of the electrochemical apparatus is increased, a higher charging voltage accelerates the oxidative decomposition of an electrolyte by a positive electrode active material (for example, high-valence transition metals in the positive electrode active material), and leads to oxygen release, further accelerating electrolyte decomposition, thus increasing gas production in the electrochemical apparatus, consequently affecting the cycling performance and high-temperature storage performance of the electrochemical apparatus.

To improve the cycling performance and high-temperature storage performance of the electrochemical apparatus, this application provides an electrolyte including a compound of Formula I-A, a compound of Formula I-B, and a compound of Formula I-C:

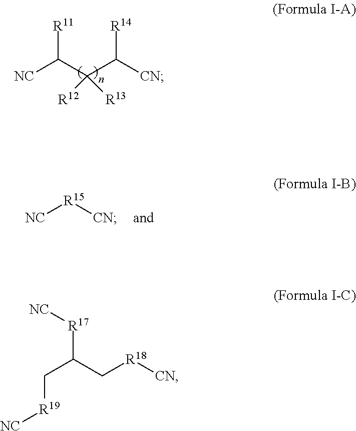

where
n is an integer selected from 1 to 8;
R¹¹, R¹², R¹³, and R¹⁴ are each independently selected from hydrogen, halogen, or a substituted or unsubstituted C₁-C₅ alkyl group, and at least one of R¹¹, R¹², R¹³, or R¹⁴ is a substituted or unsubstituted C₁-C₅ alkyl group;
R¹⁵ is selected from a C₂-C₄ alkylene group, a C₂-C₄ alkenylene group,

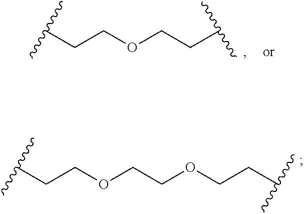 [SMILES: *CCOCC* ; *CCOCCOCC*]

R¹⁷, R¹⁸, and R¹⁹ are each independently selected from a single bond, a C₁-C₅ alkylene group, or a C₁-C₅ alkoxyalkylene group;
when substitution is performed, substituents are each independently halogen;

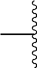

represents a connection site of two adjacent atoms; and
based on a mass of the electrolyte,
a percentage of the compound of Formula I-A is X %, with X ranging from 0.12 to 5.0,
a percentage of the compound of Formula I-B is Y %, with Y ranging from 0.12 to 5.0, and
a percentage of the compound of Formula I-C is Z %, with Z ranging from 0.12 to 3.0.

The compound of Formula I-A, the compound of Formula I-B, and the compound of Formula I-C are all polynitrile compounds. The presence of multiple cyano groups can stabilize a positive electrode active material (for example, transition metals in the positive electrode active material). The compound of Formula I-A has branched chains, which increases steric hindrance, improve protection for a positive electrode interface, but results in higher viscosity. The compound of Formula I-B has lower viscosity. The compound of Formula I-C provides strong stability to the positive electrode active material. When the percentages of the compound of Formula I-A, the compound of Formula I-B, and the compound of Formula I-C in the electrolyte are too low, the effective function is less likely to exert. As the percentages of the compound of Formula I-A, the compound of Formula I-B, and the compound of Formula I-C in the electrolyte increase, improvements in the cycling impedance growth and high-temperature storage voltage drop of the electrochemical apparatus are achieved. However, further increasing the percentages of the compound of Formula I-A, the compound of Formula I-B, and the compound of Formula I-C in the electrolyte is less likely to further improve the effect. An excessive amount of the compound of Formula I-A increases the viscosity of the electrolyte, adversely affecting the kinetic performance of the electrochemical apparatus. When the electrolyte includes specific percentages of the compound of Formula I-A, the compound of Formula I-B, and the compound of Formula I-C, the electrolyte has an appropriate viscosity, stabilizes the positive electrode active material, protects the positive electrode interface, and suppresses electrolyte decomposition, thereby significantly reducing the cycling impedance growth and high-temperature storage voltage drop of the electrochemical apparatus. This significantly improves the cycling performance and high-temperature storage performance of the electrochemical apparatus while achieving a lower viscosity electrolyte, improving the kinetic performance of the electrochemical apparatus.

In some embodiments, X ranges from 0.2 to 4.5. In some embodiments, X ranges from 0.5 to 4.2. In some embodiments, X ranges from 1.0 to 4.0. In some embodiments, X ranges from 1.5 to 3.5. In some embodiments, X ranges from 2.0 to 3.0. In some embodiments, X is 0.12, 0.2, 0.5, 1.0, 1.5, 2.0, 2.5, 3.0, 3.5, 4.0, 4.5, or 5.0, or falls within a range defined by any two of the foregoing values.

In some embodiments, Y ranges from 0.2 to 4.5. In some embodiments, Y ranges from 0.5 to 4.2. In some embodiments, Y ranges from 1.0 to 4.0. In some embodiments, Y ranges from 1.5 to 3.5. In some embodiments, Y ranges from 2.0 to 3.0. In some embodiments, Y is 0.12, 0.2, 0.5, 1.0, 1.5, 2.0, 2.5, 3.0, 3.5, 4.0, 4.5, or 5.0, or falls within a range defined by any two of the foregoing values.

In some embodiments, Z ranges from 0.2 to 2.5. In some embodiments, Z ranges from 0.5 to 2.0. In some embodiments, Z ranges from 1.0 to 1.5. In some embodiments, Z is 0.12, 0.2, 0.5, 1.0, 1.5, 2.0, 2.5, or 3.0, or falls within a range defined by any two of the foregoing values.

In some embodiments, the compound of Formula I-A includes at least one of the following compounds:

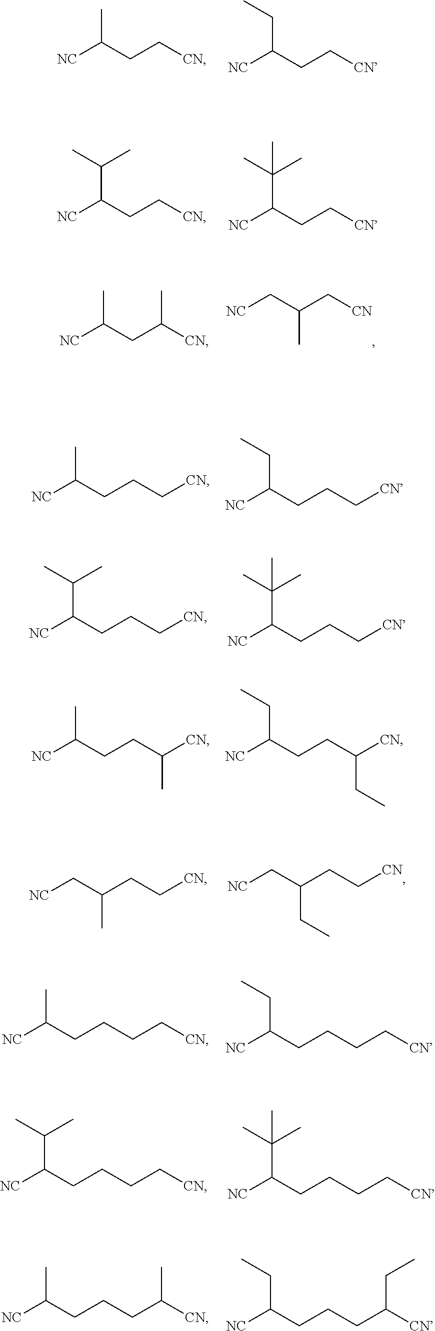

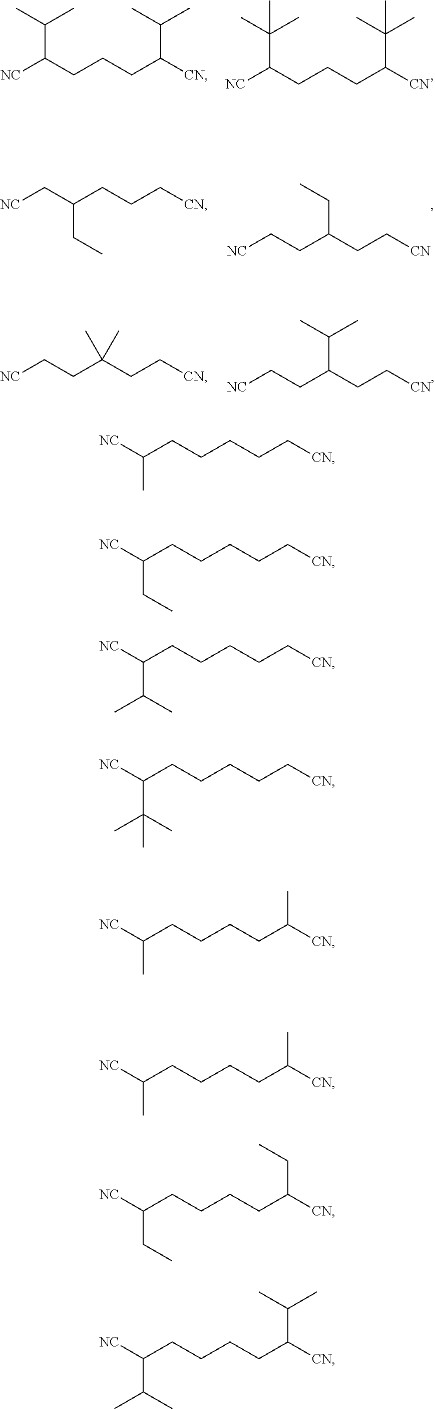

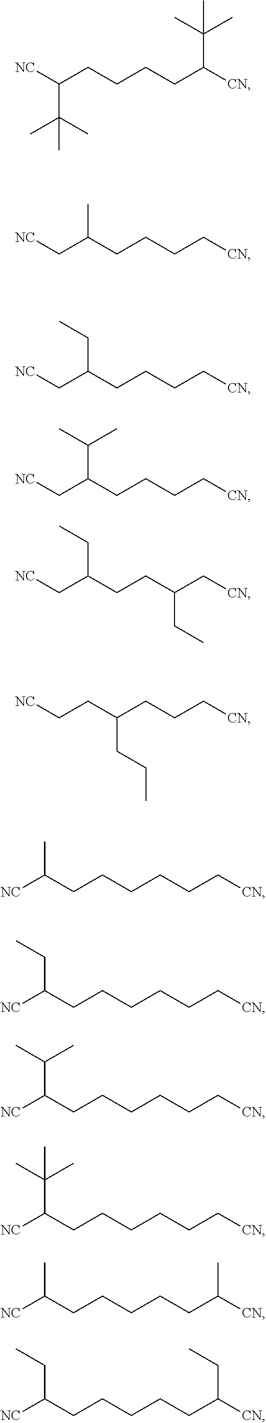

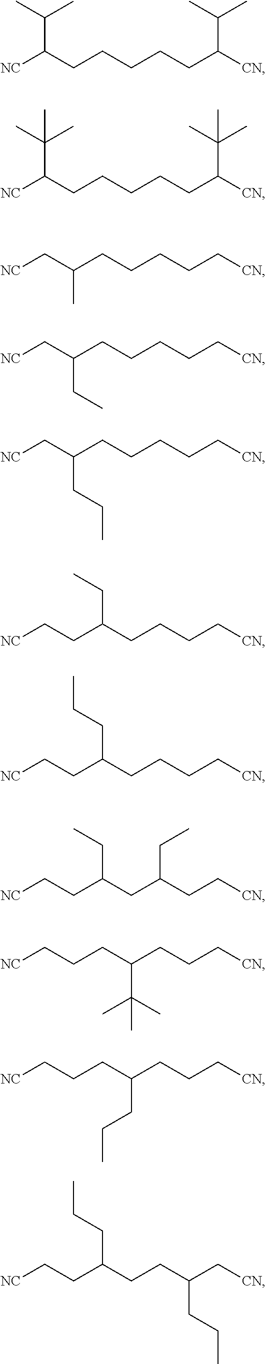

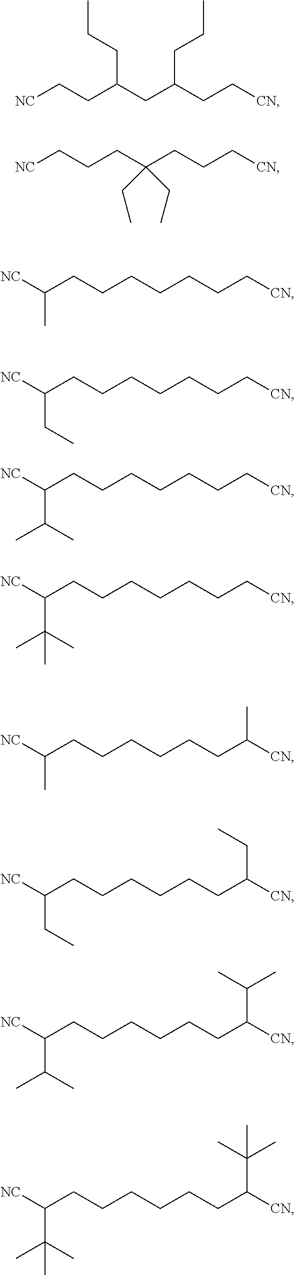

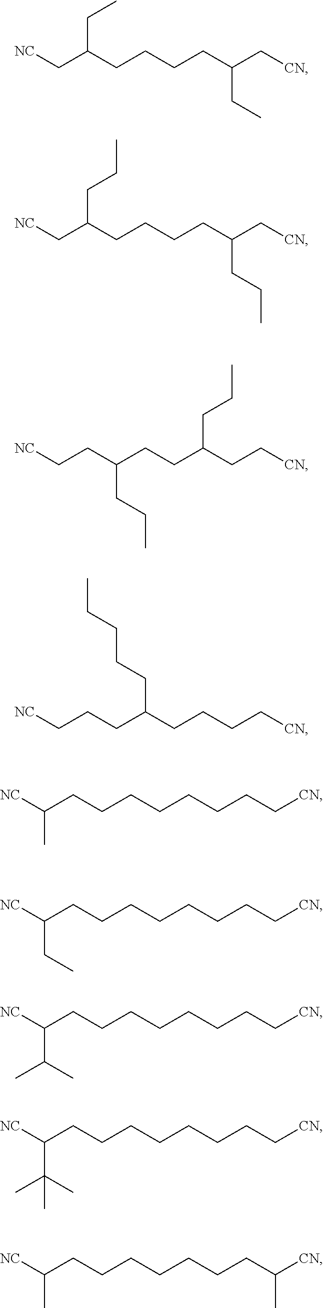

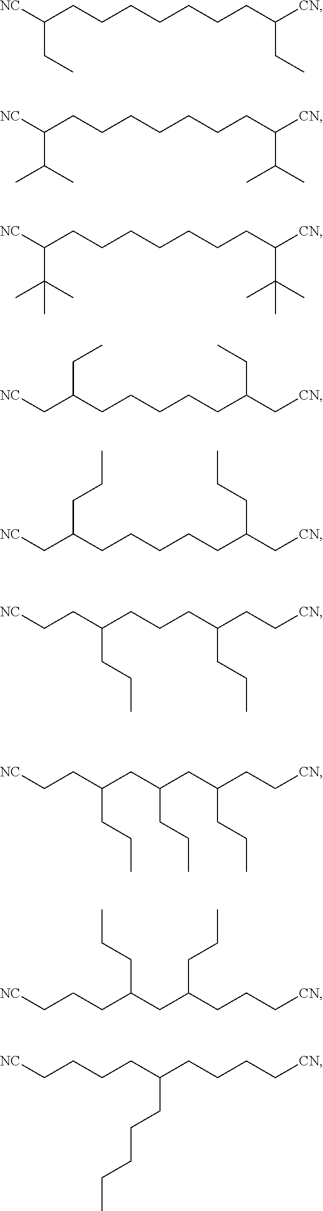

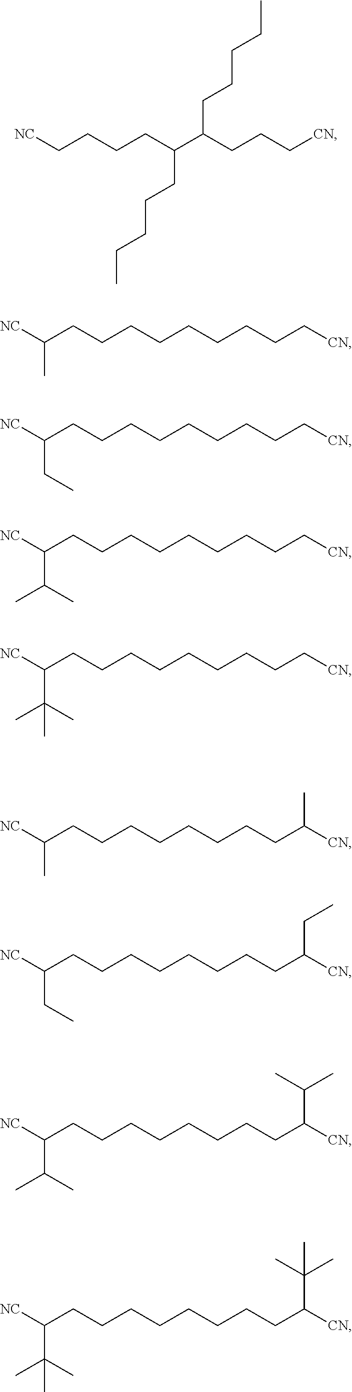

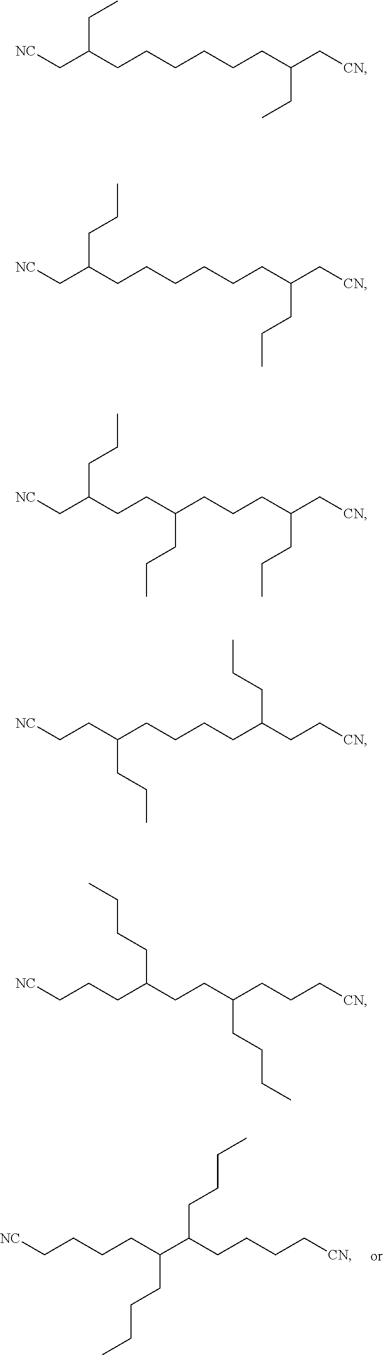 [SMILES: CCC(CC#N)CCCCCCC(CC)CC#N ; CCCC(CC#N)CCCCCCC(CC#N)CCC ; CCCC(CC#N)CCCC(CCC)CCC(CC#N)CCC ; CCCC(CCC#N)CCCCC(CCC)CCC#N ; CCCCC(CCCC#N)CCC(CCCC)CCCC#N ; CCCCC(CCCCC#N)C(CCCC)CCCCC#N]

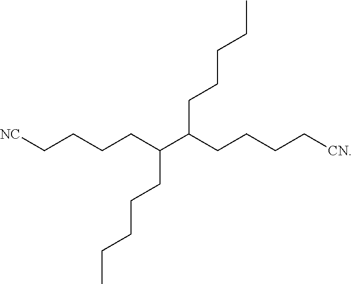 [SMILES: CCCCCC(CCCCC#N)C(CCCCC)CCCCC#N]

In some embodiments, the compound of Formula I-B includes at least one of the following compounds:

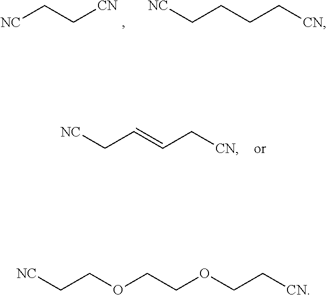 [SMILES: N#CCCC#N ; N#CCCCCC#N ; "," ; N#CC/C=C/CC#N ; N#CCCOCCOCCC#N]

In some embodiments, the compound of Formula I-C includes at least one of the following compounds:

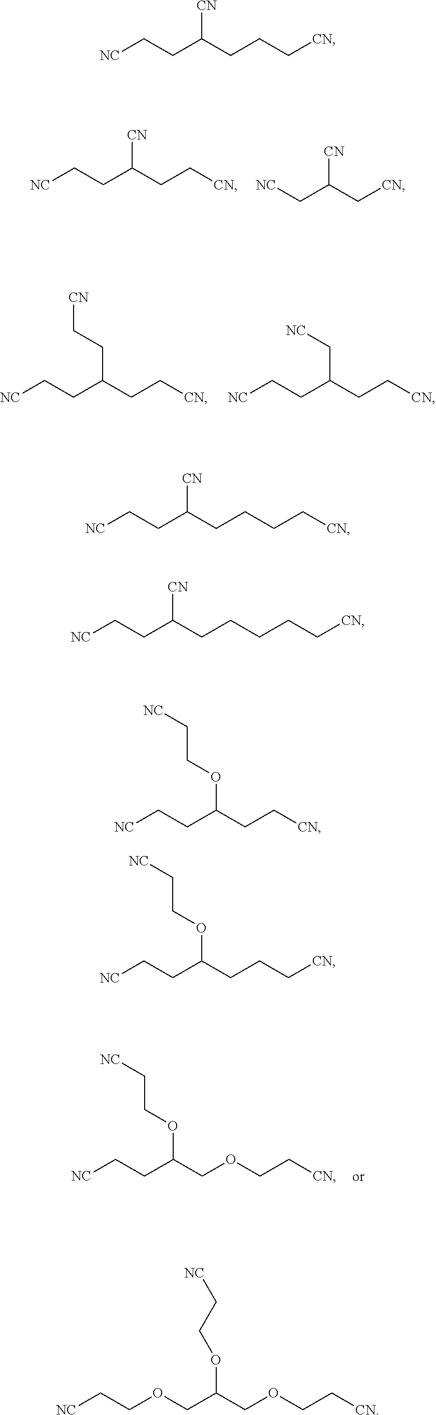

In some embodiments, Z/X ranges from 0.1 to 3. In some embodiments, Z/X ranges from 0.3 to 2.8. In some embodiments, Z/X ranges from 0.6 to 2.5. In some embodiments, Z/X ranges from 1 to 2. In some embodiments, Z/X is 0.1, 0.5, 0.6, 1, 1.5, 2, 2.5, or 3, or falls within a range defined by any two of the foregoing values. When Z/X falls within the foregoing ranges, the cycling performance and high-temperature storage performance of the electrochemical apparatus can be further improved.

In some embodiments, Y/X ranges from 0.12 to 5. In some embodiments, Y/X ranges from 0.5 to 4.5. In some embodiments, Y/X ranges from 1 to 4. In some embodiments, Y/X ranges from 1.5 to 3.5. In some embodiments, Y/X ranges from 2 to 3. In some embodiments, Y/X is 0.12, 0.2, 0.5, 1, 1.5, 2, 2.5, 3, 3.5, 4, 4.5, or 5, or falls within a range defined by any two of the foregoing values. When Y/X falls within the foregoing ranges, the cycling performance and high-temperature storage performance of the electrochemical apparatus can be further improved.

In some embodiments, the electrolyte further includes a compound containing a sulfur-oxygen double bond, and based on the mass of the electrolyte, a percentage of the compound containing a sulfur-oxygen double bond ranges from 0.01% to 10%. In some embodiments, based on the mass of the electrolyte, the percentage of the compound containing a sulfur-oxygen double bond ranges from 0.05% to 8%. In some embodiments, based on the mass of the electrolyte, the percentage of the compound containing a sulfur-oxygen double bond ranges from 0.1% to 6%. In some embodiments, based on the mass of the electrolyte, the percentage of the compound containing a sulfur-oxygen double bond ranges from 0.5% to 5%. In some embodiments, based on the mass of the electrolyte, the percentage of the compound containing a sulfur-oxygen double bond ranges from 1% to 4%. In some embodiments, based on the mass of the electrolyte, the percentage of the compound containing a sulfur-oxygen double bond ranges from 2% to 3%. In some embodiments, based on the mass of the electrolyte, the percentage of the compound containing a sulfur-oxygen double bond is 0.01%, 0.05%, 0.1%, 0.5%, 1%, 2%, 3%, 4%, 5%, 6%, 7%, 8%, 9%, or 10%, or falls within a range defined by any two of the foregoing values.

In some embodiments, the compound containing a sulfur-oxygen double bond includes a compound of Formula II:

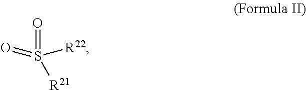

where
R²¹ and R²² are each independently selected from a substituted or unsubstituted C₁-C₅ alkyl group, a substituted or unsubstituted C₂-C₁₀ alkenyl group, a substituted or unsubstituted C₂-C₁₀ alkynyl group, a substituted or unsubstituted C₃-C₁₀ alicyclic group, a substituted or unsubstituted C₆-C₁₀ aryl group, or a substituted or unsubstituted C₁-C₅ heteroatom functional group, with a heteroatom in the heteroatom functional group selected from at least one of O or S;
R²¹ and R²² are optionally connected to form a ring; and
when substitution is performed, substituents are each independently selected from halogen.

In some embodiments, R²¹ and R²² are optionally connected to form a 5-membered ring or a 6-membered ring. In some embodiments, R²¹ and R²² are optionally connected to form a 5-membered cyclic sulfone, a 6-membered cyclic sulfone, a 5-membered cyclic sulfate, a 6-membered cyclic sulfate, a 5-membered cyclic sulfonate, a 6-membered cyclic sulfonate, a 5-membered cyclic sulfonic anhydride, or a 6-membered cyclic sulfonic anhydride.

In some embodiments, the compound containing a sulfur-oxygen double bond includes at least one of the following compounds:

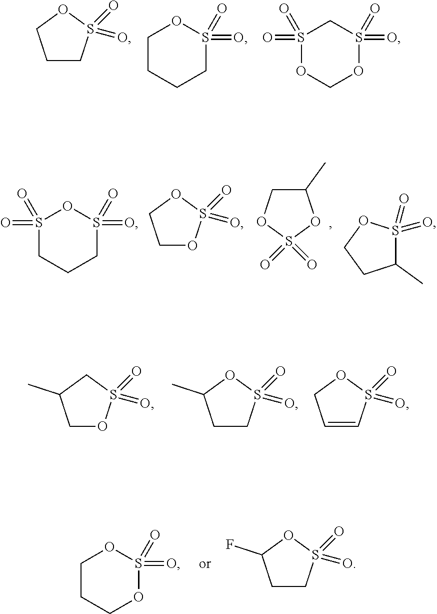

On one hand, the compound containing a sulfur-oxygen double bond has strong antioxidant capability, improving the stability of the positive electrode interface. On the other hand, the compound containing a sulfur-oxygen double bond can be reduced at a negative electrode surface to form a protective film, suppressing electrolyte decomposition and further improving the stability of a negative electrode interface. When the electrolyte further includes a specified percentage of the compound containing a sulfur-oxygen double bond, the stability of the positive electrode interface and the negative electrode interface can be effectively improved without significantly affecting the viscosity of the electrolyte or the impedance of the positive electrode interface and the negative electrode interface, further improving the cycling performance and high-temperature storage performance of the electrochemical apparatus.

In some embodiments, the electrolyte further includes a compound of Formula III:

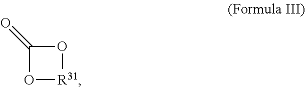

where
R³¹ is selected from a substituted or unsubstituted C₁-C₆ alkylene group or a substituted or unsubstituted C₂-C₆ alkenylene group;
when substitution is performed, substituents are each independently selected from halogen, a C₁-C₆ alkyl group, or a C₂-C₆ alkenyl group; and
based on the mass of the electrolyte, a percentage of the compound of Formula III ranges from 0.01% to 15%.

In some embodiments, based on the mass of the electrolyte, the percentage of the compound of Formula III ranges from 0.05% to 12%. In some embodiments, based on the mass of the electrolyte, the percentage of the compound of Formula III ranges from 0.1% to 10%. In some embodiments, based on the mass of the electrolyte, the percentage of the compound of Formula III ranges from 0.5% to 8%. In some embodiments, based on the mass of the electrolyte, the percentage of the compound of Formula III ranges from 1% to 5%. In some embodiments, based on the mass of the electrolyte, the percentage of the compound of Formula III ranges from 2% to 4%. In some embodiments, based on the mass of the electrolyte, the percentage of the compound of Formula III is 0.01%, 0.05%, 0.1%, 0.5%, 1%, 2%, 3%, 4%, 5%, 6%, 7%, 8%, 9%, 10%, 11%, 12%, 13%, 14%, or 15%, or falls within a range defined by any two of the foregoing values.

In some embodiments, the compound of Formula III includes at least one of the following compounds:

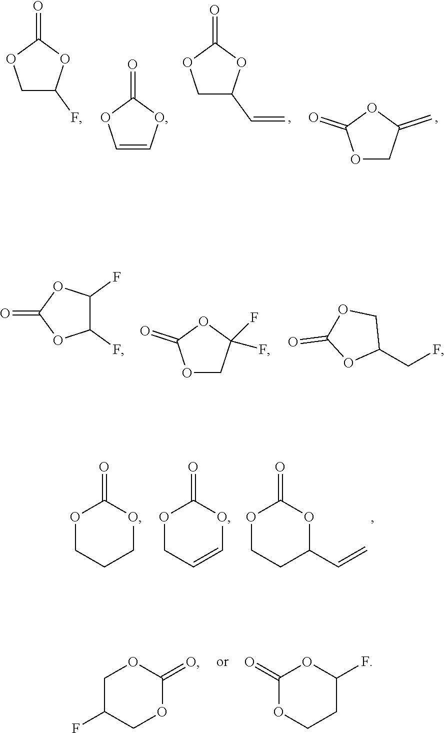

The compound of Formula III can assist in improving the film-forming stability of a solid electrolyte interphase (SEI) on a negative electrode, increasing the flexibility of the SEI film, improving the protective effect on a negative electrode active material, and reducing the contact probability between the negative electrode active material and the electrolyte, thereby reducing the impedance of the electrochemical apparatus during cycling. When the electrolyte further includes a specified percentage of the compound of Formula III, the negative electrode interface can be adequately protected, further improving the cycling performance and high-temperature storage performance of the electrochemical apparatus.

In some embodiments, the electrolyte further includes a compound IV, and the compound IV includes at least one of the following compounds:

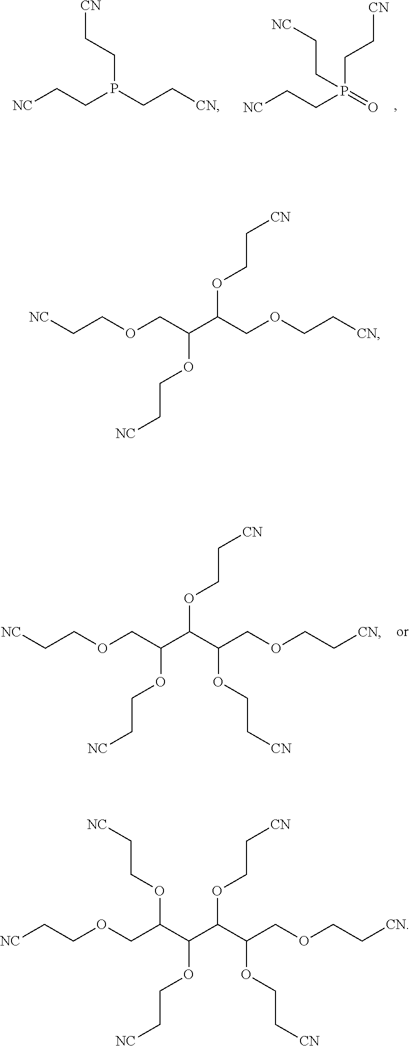 [SMILES: N#CCCP(CCC#N)CCC#N ; N#CCCP(=O)(CCC#N)CCC#N ; N#CCCOCC(OCCC#N)C(COCCC#N)OCCC#N ; N#CCCOCC(OCCC#N)C(OCCC#N)C(COCCC#N)OCCC#N ; N#CCCOCC(OCCC#N)C(OCCC#N)C(OCCC#N)C(COCCC#N)OCCC#N]

The compound IV contains at least three cyano groups (—CN), providing stronger protection to the positive electrode interface. The compound IV works synergistically with the compound of Formula I-A, the compound of Formula I-B, and the compound of Formula I-C in the electrolyte to further suppress electrolyte decomposition, thereby further reducing the cycling impedance growth and high-temperature storage thickness swelling rate of the electrochemical apparatus, and further significantly improving the cycling performance and high-temperature storage performance of the electrochemical apparatus.

In some embodiments, based on the mass of the electrolyte, a percentage of the compound IV ranges from 0.01% to 2%. In some embodiments, based on the mass of the electrolyte, the percentage of the compound IV ranges from 0.05% to 1.5%. In some embodiments, based on the mass of the electrolyte, the percentage of the compound IV ranges from 0.1% to 1%. In some embodiments, based on the mass of the electrolyte, the percentage of the compound IV ranges from 0.2% to 0.5%. In some embodiments, based on the mass of the electrolyte, the percentage of the compound IV is 0.01%, 0.05%, 0.1%, 0.5%, 1%, 1.5%, or 2%, or falls within a range defined by any two of the foregoing values. When the percentage of the compound IV in the electrolyte falls within the foregoing ranges, the cycling performance and high-temperature storage performance of the electrochemical apparatus can be further improved.

In some embodiments, the electrolyte further includes a boron-containing lithium salt, and based on the mass of the electrolyte, a percentage of the boron-containing lithium salt ranges from 0.01% to 1%. In some embodiments, based on the mass of the electrolyte, the percentage of the boron-containing lithium salt ranges from 0.05% to 0.8%. In some embodiments, based on the mass of the electrolyte, the percentage of the boron-containing lithium salt ranges from 0.1% to 0.6%. In some embodiments, based on the mass of the electrolyte, the percentage of the boron-containing lithium salt ranges from 0.2% to 0.5%. In some embodiments, based on the mass of the electrolyte, the percentage of the boron-containing lithium salt is 0.01%, 0.05%, 0.1%, 0.2%, 0.3%, 0.4%, 0.5%, 0.6%, 0.7%, 0.8%, 0.9%, or 1%, or falls within a range defined by any two of the foregoing values.

In some embodiments, the boron-containing lithium salt includes at least one of lithium tetrafluoroborate, lithium bis(oxalate)borate, or lithium difluoro(oxalate)borate.

The boron-containing lithium salt can form a film on a positive electrode, working synergistically with the compound of Formula I-A, the compound of Formula I-B, and the compound of Formula I-C to stabilize the positive electrode interface. When the electrolyte further includes a specified percentage of the boron-containing lithium salt, the cycling impedance growth of the electrochemical apparatus can be further reduced, further significantly improving the cycling performance of the electrochemical apparatus.

In some embodiments, based on the mass of the electrolyte, the percentage of the boron-containing lithium salt is M %, and M/X is not greater than 1. In some embodiments, M/X ranges from 0.01 to 0.8. In some embodiments, M/X ranges from 0.05 to 0.6. In some embodiments, M/X ranges from 0.1 to 0.5. In some embodiments, M/X ranges from 0.2 to 0.4. In some embodiments, M/X is 0.01, 0.02, 0.05, 0.1, 0.2, 0.3, 0.4, 0.5, 0.6, 0.7, 0.8, 0.9, or 1, or falls within a range defined by any two of the foregoing values. When M/X falls within the foregoing ranges, the cycling performance and high-temperature storage performance of the electrochemical apparatus can be further significantly improved.

In some embodiments, the electrolyte may further include another non-aqueous organic solvent and electrolytic salt. The non-aqueous organic solvent may include at least one of carbonate, carboxylate, ether, or another aprotic solvent. Examples of a carbonate solvent include dimethyl carbonate, diethyl carbonate, ethyl methyl carbonate, methyl propyl carbonate, ethyl propyl carbonate, dipropyl carbonate, ethylene carbonate, propylene carbonate, butylene carbonate, bis(2,2,2-trifluoroethyl) carbonate, and the like. Examples of a carboxylate solvent include methyl acetate, ethyl acetate, n-propyl acetate, n-butyl acetate, methyl propionate, ethyl propionate, propyl propionate, butyl propionate, methyl butyrate, ethyl butyrate, propyl butyrate, butyl butyrate, γ-butyrolactone, 2,2-difluoroethyl acetate, valerolactone, butyrolactone, 2-fluoroethyl acetate, 2,2-difluoroethyl acetate, ethyl trifluoroacetate, ethyl 2,2,3,3,3-pentafluoropropionate, methyl 2,2,3,3,4,4,4,4-heptafluorobutyrate, methyl 4,4,4-trifluoro-3-(trifluoromethyl)butyrate, ethyl 2,2,3,3,4,4,5,5,5,5-nonafluoropentanoate, methyl 2,2,3,3,4,4,5,5,6,6,7,7,8,8,9,9,9-heptadecafluorononanoate, ethyl 2,2,3,3,4,4,5,5,6,6,7,7,8,8,9,9,9-heptadecafluorononanoate, and the like. Examples of an ether solvent include ethylene glycol dimethyl ether, diethylene glycol dimethyl ether, tetraethylene glycol dimethyl ether, dibutyl ether, tetrahydrofuran, 2-methyltetrahydrofuran, bis(2,2,2-trifluoroethyl) ether, and the like.

In some embodiments, the electrolytic salt includes at least one of an organic lithium salt or an inorganic lithium salt. In some embodiments, the electrolytic salt includes at least one of lithium hexafluorophosphate LiPF₆, lithium bis(trifluoromethanesulfonyl)imide (LiN(CF₃SO₂)₂, abbreviated as LiTFSI), lithium bis(fluorosulfonyl)imide (Li(N(SO₂F)₂), abbreviated as LiFSI), lithium hexafluorocesium (LiCsF₆), lithium perchlorate LiClO₄, or lithium trifluoromethanesulfonate (LiCF₃SO₃).

In some embodiments, based on the mass of the electrolyte, a percentage of the electrolytic salt ranges from 10% to 15%. In some embodiments, based on the mass of the electrolyte, a mass percentage of the electrolytic salt ranges from 12% to 15%. When the percentage of the electrolytic salt falls within the foregoing ranges, the electrolyte has appropriate ionic conductivity and viscosity, allowing the electrochemical apparatus to have good rate performance and cycling performance.

This application further provides an electrochemical apparatus. The electrochemical apparatus includes an electrode assembly and an electrolyte, where the electrode assembly includes a positive electrode, a negative electrode, and a separator disposed between the positive electrode and the negative electrode. In some embodiments, the electrolyte is the electrolyte described in this application.

In some embodiments, the negative electrode may include a negative electrode current collector and a negative electrode active material layer disposed on the negative electrode current collector. The negative electrode active material layer may be disposed on one side or both sides of the negative electrode current collector. In some embodiments, the negative electrode current collector may include at least one of a copper foil, an aluminum foil, a nickel foil, or a carbon-based current collector. In some embodiments, a thickness of the negative electrode current collector may range from 1 μm to 200 μm. In some embodiments, the negative electrode active material layer may be applied only on a partial region of the negative electrode current collector. In some embodiments, a thickness of the negative electrode active material layer may range from 10 μm to 500 μm. It should be understood that these thicknesses are merely examples, and any other suitable thicknesses may be adopted.

In some embodiments, the negative electrode active material layer includes a negative electrode active material. In some embodiments, the negative electrode active material in the negative electrode active material layer includes at least one of lithium metal, natural graphite, artificial graphite, or a silicon-based material. In some embodiments, the silicon-based material includes at least one of silicon, a silicon-oxygen compound, a silicon-carbon compound, or a silicon alloy.

In some embodiments, the negative electrode active material layer may further include a conductive agent and/or a binder. The conductive agent in the negative electrode active material layer may include at least one of carbon black, acetylene black, Ketjen black, lamellar graphite, graphene, carbon nanotubes, carbon fiber, or carbon nanowires. In some embodiments, the binder in the negative electrode active material layer may include at least one of carboxymethyl cellulose (CMC), a polyacrylic acid, a polyacrylate salt, a polyacrylate ester, polyvinylpyrrolidone, polyaniline, polyimide, polyamideimide, polysiloxane, styrene-butadiene rubber, epoxy resin, polyester resin, polyurethane resin, or polyfluorene. It should be understood that the materials disclosed above are merely examples, and any other suitable materials may be used for the negative electrode active material layer. In some embodiments, a mass ratio of the negative electrode active material, conductive agent, and binder in the negative electrode active material layer may be (80-99):(0.5-10):(0.5-10). It should be understood that this is merely an example and is not used to limit this application.

In some embodiments, the positive electrode includes a positive electrode current collector and a positive electrode active material layer disposed on the positive electrode current collector. The positive electrode active material layer may be located on one side or both sides of the positive electrode current collector. In some embodiments, the positive electrode current collector may be an aluminum foil. Certainly, other positive electrode current collectors commonly used in the art may also be used. In some embodiments, a thickness of the positive electrode current collector may range from 1 μm to 200 μm. In some embodiments, the positive electrode active material layer may be applied only on a partial region of the positive electrode current collector. In some embodiments, a thickness of the positive electrode active material layer may range from 10 μm to 500 μm. It should be understood that these thicknesses are merely examples, and any other suitable thicknesses may be adopted.

In some embodiments, the positive electrode active material layer includes a positive electrode active material. In some embodiments, the positive electrode active material includes LiCoO₂, LiNiO₂, LiMn₂O₄, LiCo_{1-y}M_{y}O₂, LiNi_{1-y}M_{y}O₂, LiMn_{2-y}M_{y}O₄, and LiNiₓCo_{y}Mn_{z}M_{1-x-y-z}O₂, where M is selected from at least one of Fe, Co, Ni, Mn, Mg, Cu, Zn, Al, Sn, B, Ga, Cr, Sr, V, or Ti, 0≤y≤1, 0≤x≤1, 0≤z≤1, and x+y+z≤1. In some embodiments, the positive electrode active material may include at least one of lithium cobaltate, lithium manganate, lithium iron phosphate, lithium manganese iron phosphate, lithium nickel cobalt manganate, lithium nickel cobalt aluminate, or lithium nickel manganate, and the positive electrode active material may undergo doping and/or coating treatment.

In some embodiments, the positive electrode active material layer further includes a binder and a conductive agent. In some embodiments, the binder in the positive electrode active material layer may include at least one of polyvinylidene fluoride, a vinylidene fluoride-hexafluoropropylene copolymer, a styrene-acrylate copolymer, a styrene-butadiene copolymer, polyamide, polyacrylonitrile, a polyacrylate ester, a polyacrylic acid, a polyacrylate salt, sodium carboxymethyl cellulose, polyvinyl acetate, polyvinylpyrrolidone, polyvinyl ether, polymethyl methacrylate, polytetrafluoroethylene, or polyhexafluoropropylene. In some embodiments, the conductive agent in the positive electrode active material layer may include at least one of conductive carbon black, acetylene black, Ketjen black, lamellar graphite, graphene, carbon nanotubes, or carbon fiber. In some embodiments, a mass ratio of the positive electrode active material, conductive agent, and binder in the positive electrode active material layer may be (70-98):(1-15):(1-15). It should be understood that the descriptions above are merely examples, and any other suitable materials, thicknesses, and mass ratios may be adopted for the positive electrode active material layer.

In some embodiments, the separator includes at least one of polyethylene, polypropylene, polyvinylidene fluoride, polyethylene terephthalate, polyimide, or aramid. For example, polyethylene includes at least one selected from high-density polyethylene, low-density polyethylene, or ultra-high molecular weight polyethylene. In particular, polyethylene and polypropylene provide effective short-circuit prevention and improve battery stability through a shutdown effect. In some embodiments, a thickness of the separator ranges from approximately 3 μm to 500 μm.

In some embodiments, a separator surface may further include a porous layer, the porous layer is disposed on at least one surface of the separator, and the porous layer includes at least one of inorganic particles or a binder, where the inorganic particles are selected from at least one of aluminum oxide (Al₂O₃), silicon oxide (SiO₂), magnesium oxide (MgO), titanium oxide (TiO₂), hafnium dioxide (HfO₂), tin oxide (SnO₂), cerium dioxide (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide, or barium sulfate. In some embodiments, pores of the separator have a diameter ranging from approximately 0.01 μm to 1 μm. The binder of the porous layer is selected from at least one of polyvinylidene fluoride, a vinylidene fluoride-hexafluoropropylene copolymer, polyamide, polyacrylonitrile, a polyacrylate ester, a polyacrylic acid, a polyacrylate salt, sodium carboxymethyl cellulose, polyvinylpyrrolidone, polyvinyl ether, polymethyl methacrylate, polytetrafluoroethylene, or polyhexafluoropropylene. The porous layer on the separator surface can improve the heat resistance, oxidation resistance, and electrolyte infiltration of the separator and improve adhesion between the separator and an electrode plate.

In some embodiments of this application, the electrode assembly of the electrochemical apparatus is a wound electrode assembly or a stacked electrode assembly. In some embodiments, the electrochemical apparatus is a lithium-ion battery, but this application is not limited thereto.

In some embodiments of this application, when a lithium-ion battery is used as an example, a positive electrode, a separator, and a negative electrode are sequentially wound or stacked to form an electrode assembly, then the electrode assembly is placed in, for example, an aluminum-plastic film casing for encapsulation, and an electrolyte is injected, followed by formation and packaging to prepare a lithium-ion battery. Then, the prepared lithium-ion battery undergoes performance testing.

Persons skilled in the art will understand that the preparation method of the electrochemical apparatus (for example, a lithium-ion battery) described above is merely an example. Other methods commonly used in the art may be used without departing from the content disclosed in this application.

This application further provides an electronic apparatus including the electrochemical apparatus described in this application. The electronic apparatus of some embodiments of this application is not particularly limited and may be any electronic apparatus known in the prior art. In some embodiments, the electronic apparatus may include but is not limited to a notebook computer, a pen-input computer, a mobile computer, an e-book reader, a portable phone, a portable fax machine, a portable copier, a portable printer, a head-mounted stereo headset, a video recorder, a liquid crystal television, a portable cleaner, a portable CD player, a mini-disc player, a transceiver, an electronic notebook, a calculator, a memory card, a portable recorder, a radio, a backup power supply, a motor, an automobile, a motorcycle, a power-assisted bicycle, a bicycle, a lighting fixture, a toy, a gaming console, a clock, an electric tool, a flash lamp, a camera, a large household battery, and a lithium-ion capacitor.

The following takes a lithium-ion battery as an example and describes the preparation of the lithium-ion battery in conjunction with specific embodiments. Persons skilled in the art will understand that the preparation method described in this application is merely an example, and any other suitable preparation methods fall within the scope of this application.

### Examples

The following describes the performance evaluation of lithium-ion batteries according to examples and comparative examples of this application.

### I. Preparation of Lithium-Ion Battery

### 1. Preparation of Positive Electrode

Lithium cobaltate (LiCoO₂), conductive carbon black, and polyvinylidene fluoride (PVDF) were dissolved in N-methylpyrrolidone (NMP) at a weight ratio of 97.9:0.9:1.2, and fully stirred and mixed well to form a positive electrode slurry. A 13 μm aluminum foil was used as a positive electrode current collector. The positive electrode slurry was applied on the positive electrode current collector, followed by drying, cold pressing, and cutting to obtain a positive electrode. A compacted density of the positive electrode was 4.15 g/cm³.

### 2. Preparation of Negative Electrode

Artificial graphite, styrene-butadiene rubber (SBR), and sodium carboxymethyl cellulose (CMC) were dissolved in deionized water at a weight ratio of 97.4:1.4:1.2 to form a negative electrode slurry. A 10 μm thick copper foil was used as a negative electrode current collector. The negative electrode slurry was applied on the negative electrode current collector, followed by drying, cold pressing, and cutting to obtain a negative electrode. A compacted density of the negative electrode was 1.8 g/cm³.

### 3. Preparation of Separator

A separator substrate was a 5 μm thick polyethylene (PE) film. Both sides of the separator substrate were each coated with a 2 μm thick aluminum oxide ceramic layer, and then both sides of the separator coated with a single ceramic layer were each coated with 2.5 mg of polyvinylidene fluoride (PVDF), and then drying was performed to obtain a separator.

### 4. Preparation of Electrolyte

In an environment with a water content of less than 10 ppm, ethylene carbonate (EC), propylene carbonate (PC), diethyl carbonate (DEC), ethyl propionate (EP), and propyl propionate (PP) were mixed well at a mass ratio of 1:1:1:1:1, and an electrolytic salt LiPF₆ was dissolved in the above non-aqueous solvents. Then, the resulting solution was mixed well to form a base electrolyte, where a mass percentage of LiPF₆ was 12.5%.

According to the settings of the following examples or comparative examples, specified amounts of additives were added to the base electrolyte to obtain the electrolytes of the examples or comparative example.

The additives used in the examples or comparative example are shown in the table below:

| Abbreviation/Number | Compound |
|---|---|
| MGLN | 2-methyl glutaronitrile |
| DMADN | 2,5-dimethylhexanedinitrile |
| EHDN | 4-ethylheptanedinitrile |
| DEODN | 3,6-diethyloctanedinitrile |
| DEAN | 4,6-diethylnonanedinitrile |
| SN | succinonitrile |
| ADN | adiponitrile |
| HTCN | 1,3,6-hexanetricarbonitrile |
| TCEP | 1,2,3-tris(2-cyanoethoxy)propane |
| POTPN | 3,3′,3″-(oxy-phosphoryltriyl)tripropionitrile |
| LiBOB | lithium bis(oxalate)borate |
| II-1 | 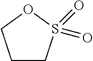 |
| II-2 | 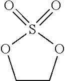 |
| III-1 | 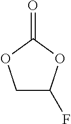 |
| III-2 | 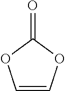 |

### 5. Preparation of Lithium-Ion Battery

The positive electrode, the separator, and the negative electrode were sequentially stacked in order, where the separator is located between the positive electrode and the negative electrode to provide isolation. The resulting stack was wound to obtain an electrode assembly. The electrode assembly was placed in an aluminum-plastic film outer package. After dehydration was performed at 80° C., the above-mentioned electrolyte was injected and packaging was performed, followed by processes such as formation, degassing, and trimming to obtain a lithium-ion battery.

II. Test methods

### 1. Testing Method for Cycling Performance of Lithium-Ion Battery

At 25° C., a lithium-ion battery was charged at 0.7C to 4.5 V, and charged at a constant voltage of 4.5 V to 0.05C. Then, the lithium-ion battery was discharged at 0.7C to 3.0 V, and with a process of charging at 0.7C and discharging at 1C was performed for 800 cycles. Discharge capacities of the 3rd cycle and the 800th cycle were tested, and the impedance after the 3rd cycle and the impedance after the 300th cycle were tested at 1000 Hz. A cycling capacity retention rate and a cycling impedance growth rate of the lithium-ion battery were calculated using the following formulas:

$$cycling capacity retention rate = discharge capacity of the 800 th cycle / discharge capacity of the 3 rd cycle \times 100 \% ;$$

$$and$$

$$cycling impedance growth rate = impedance after the 300 th cycle / impedance after the 3 rd cycle \times 100 \% .$$

### 2. Testing Method for High-Temperature Storage Performance of Lithium-Ion Battery

At 25° C., a lithium-ion battery was charged at a constant current of 0.5C to 4.55 V, then charged at a constant voltage until the current reached 0.05C, an open-circuit voltage was recorded as V0, and a thickness of the lithium-ion battery was recorded as d0. The lithium-ion battery was placed in an oven at 60° C. for 20 days, then a thickness was measured and recorded as d, and a voltage was tested and recorded as V1.

A high-temperature storage thickness swelling rate and high-temperature storage voltage drop of the lithium-ion battery were calculated using the following formulas:

$$\text{high-temperature} storage thickness swelling rate = ( d - d 0 ) / d 0 \times 100 \% ;$$

$$and$$

$$\text{high-temperature} storage voltage drop = V 0 - V 1.$$

When the thickness swelling rate of the lithium-ion battery exceeded 50%, the test was stopped.

### III. Test Results

Table 1 shows the influence of the compound of Formula I-A, the compound of Formula I-B, the compound of Formula I-C, and their percentages in the electrolyte on the cycling performance and high-temperature storage performance of the lithium-ion battery.

TABLE 1

| | Compound of | | Compound of | | Compound of | | | | | |
|---|---|---|---|---|---|---|---|---|---|---|
| | Formula I-A | | Formula I-B | | Formula I-C | | | | | |
| | | Percentage | | Percentage | | Percentage | | | | High-temperature |
| | | X | | Y | | Z | | | Cycling impedance | storage voltage |
| | Compound | (wt %) | Compound | (wt %) | Compound | (wt %) | Z/X | Y/X | growth rate | drop (V) |
| Example 1 | MGLN | 1 | SN | 2 | HTCN | 1 | 1 | 2 | 29.7% | 0.20 |
| Example 2 | MGLN | 3 | SN | 2 | HTCN | 1 | 0.33 | 0.67 | 27.8% | 0.18 |
| Example 3 | MGLN | 5 | SN | 2 | HTCN | 1 | 0.2 | 0.4 | 30.1% | 0.20 |
| Example 4 | MGLN | 2 | SN | 1 | HTCN | 1 | 0.5 | 1.5 | 28.2% | 0.18 |
| | | | ADN | 2 | | | | | | |
| Example 5 | EHDN | 2 | SN | 2 | HTCN | 1 | 0.5 | 1 | 29.1% | 0.18 |
| Example 6 | DEODN | 2 | SN | 2 | TCEP | 1 | 0.5 | 1 | 28.0% | 0.17 |
| Example 7 | DEAN | 2 | SN | 1 | HTCN | 1 | 0.5 | 1.5 | 27.5% | 0.16 |
| | | | ADN | 2 | | | | | | |
| Example 8 | MGLN | 1 | SN | 3 | HTCN | 1 | 1 | 5 | 29.9% | 0.19 |
| | | | ADN | 2 | | | | | | |
| Example 9 | MGLN | 1 | SN | 2 | HTCN | 3 | 3 | 2 | 30.3% | 0.20 |
| Example 10 | MGLN | 0.12 | SN | 2 | HTCN | 1 | 8.33 | 16.67 | 31.6% | 0.23 |
| Example 11 | MGLN | 1 | SN | 0.12 | HTCN | 1 | 1 | 0.12 | 31.8% | 0.24 |
| Example 12 | MGLN | 1 | SN | 2 | HTCN | 0.12 | 0.12 | 2 | 31.5% | 0.23 |
| Example 13 | MGLN | 2 | SN | 2 | HTCN | 1 | 0.5 | 1 | 28.9% | 0.18 |
| Example 14 | MGLN | 2 | ADN | 2 | HTCN | 1 | 0.5 | 1 | 28.7% | 0.18 |
| Example 15 | MGLN | 1 | SN | 2 | HTCN | 1 | 0.5 | 1 | 28.2% | 0.17 |
| | DEAN | 1 | | | | | | | | |
| Example 16 | MGLN | 0.5 | SN | 2 | HTCN | 1 | 2 | 4 | 30.9% | 0.23 |
| Example 17 | MGLN | 4.2 | SN | 2 | HTCN | 1 | 0.24 | 0.48 | 28.2% | 0.19 |
| Example 18 | MGLN | 1 | SN | 0.5 | HTCN | 1 | 1 | 0.5 | 31.5% | 0.23 |
| Example 19 | MGLN | 1 | SN | 2.2 | HTCN | 1 | 1 | 4.2 | 29.1% | 0.19 |
| | | | ADN | 2 | | | | | | |
| Example 20 | MGLN | 1 | SN | 2 | HTCN | 0.5 | 0.5 | 2 | 30.5% | 0.23 |
| Example 21 | MGLN | 1 | SN | 2 | HTCN | 0.6 | 0.6 | 2 | 30.2% | 0.23 |
| Example 22 | MGLN | 1 | SN | 2 | HTCN | 2.5 | 2.5 | 2 | 28.6% | 0.19 |
| Example 23 | MGLN | 1 | SN | 0.6 | HTCN | 1 | 1 | 0.6 | 31.3% | 0.23 |
| Example 24 | MGLN | 1 | SN | 2.5 | HTCN | 1 | 1 | 2.5 | 28.5% | 0.19 |
| Example 25 | DMADN | 1 | SN | 2 | HTCN | 1 | 1 | 0.1 | 29.8% | 0.21 |
| Comparative | — | — | SN | 1 | — | — | — | — | 49.2% | 0.29 |
| example 1 | | | | | | | | | | |
| Comparative | MGLN | 1 | — | — | — | — | — | — | 36.9% | 0.27 |
| example 2 | | | | | | | | | | |
| Comparative | MGLN | 1 | SN | 2 | — | — | — | 2 | 35.7% | 0.24 |
| example 3 | | | | | | | | | | |
| Comparative | — | — | — | — | HTCN | 1 | — | — | 36.2% | 0.27 |
| example 4 | | | | | | | | | | |
| Comparative | MGLN | 6 | SN | 2 | HTCN | 1 | 0.017 | 0.33 | 32.5% | 0.22 |
| example 5 | | | | | | | | | | |
| Comparative | MGLN | 1 | SN | 2 | HTCN | 3.5 | 3.5 | 2 | 32.2% | 0.21 |
| example 6 | | | | | | | | | | |

As shown in Comparative examples 1 to 4, when the electrolyte contains only one or two of the compound of Formula I-A, the compound of Formula I-B, and the compound of Formula I-C, the lithium-ion battery exhibits a high cycling impedance growth rate and high-temperature storage voltage drop. As shown in Comparative examples 5 and 6, although the electrolyte contains the compound of Formula I-A, the compound of Formula I-B, and the compound of Formula I-C, the percentage of the compound of Formula I-A in Comparative example 5 and the percentage of the compound of Formula I-C in Comparative example 6 are excessively high, resulting in an insignificant effect of reducing the cycling impedance growth rate of the lithium-ion battery, and potentially leading to increased costs, still failing to meet usage requirements.

As shown in Examples 1 to 25, when the electrolyte contains 0.12% to 5.0% of the compound of Formula I-A, 0.12% to 5.0% of the compound of Formula I-B, and 0.12% to 3.0% of the compound of Formula I-C, the cycling impedance growth rate and high-temperature storage voltage drop of the lithium-ion battery are significantly reduced. When the percentage of the compound of Formula I-A in the electrolyte ranges from 0.5% to 4.2%, the percentage of the compound of Formula I-B ranges from 0.5% to 4.2%, and the percentage of the compound of Formula I-C ranges from 0.5% to 3.0%, the cycling impedance growth rate and high-temperature storage voltage drop of the lithium-ion battery can be further reduced.

When the percentage (Z %) of the compound of Formula I-C and the percentage (X %) of the compound of Formula I-A in the electrolyte satisfy Z/X in the range of 0.1 to 3.0, the cycling impedance growth rate and high-temperature storage voltage drop of the lithium-ion battery can be further reduced. When Z/X ranges from 0.6 to 2.5, the cycling impedance growth rate and high-temperature storage voltage drop of the lithium-ion battery are further optimized.

When the percentage (Y %) of the compound of Formula I-B and the percentage (X %) of the compound of Formula I-A in the electrolyte satisfy Y/X in the range of 0.12 to 5.0, the cycling impedance growth rate and high-temperature storage voltage drop of the lithium-ion battery can be further reduced.

Table 2 shows the influence of the compound containing a sulfur-oxygen double bond, the compound IV, the boron-containing lithium salt, and their percentages in the electrolyte on the cycling performance and high-temperature storage performance of the lithium-ion battery.

TABLE 2

| | | | | | | | Compound | |
|---|---|---|---|---|---|---|---|---|
| | Compound of | | Compound of | | Compound of | | containing | |
| | Formula I-A | | Formula I-B | | Formula I-C | | sulfur-oxygen | |
| | | Percentage | | Percentage | | Percentage | double bond | |
| | | X | | Y | | Z | | Percentage |
| | Compound | (wt %) | Compound | (wt %) | Compound | (wt %) | Compound | (wt %) |
| Example 1 | MGLN | 1 | SN | 2 | HTCN | 1 | — | — |
| Example 16 | MGLN | 1 | SN | 2 | HTCN | 1 | II-1 | 0.1 |
| Example 17 | MGLN | 1 | SN | 2 | HTCN | 1 | II-1 | 1 |
| Example 18 | MGLN | 1 | SN | 2 | HTCN | 1 | II-1 | 3 |
| Example 19 | MGLN | 1 | SN | 2 | HTCN | 1 | II-1 | 5 |
| Example 20 | MGLN | 1 | SN | 2 | HTCN | 1 | II-1 | 7 |
| | | | | | | | II-2 | 3 |
| Example 21 | MGLN | 1 | SN | 2 | HTCN | 1 | II-1 | 7 |
| | | | | | | | II-2 | 3.5 |
| Example 22 | DEODN | 1 | SN | 2 | HTCN | 1 | II-1 | 3 |
| Example 23 | MGLN | 1 | SN | 2 | HTCN | 1 | — | — |
| Example 24 | MGLN | 1 | SN | 2 | HTCN | 1 | — | — |
| Example 25 | MGLN | 1 | SN | 2 | HTCN | 1 | — | — |
| Example 26 | MGLN | 1 | SN | 2 | HTCN | 1 | — | — |
| Example 27 | MGLN | 1 | SN | 2 | HTCN | 1 | — | — |
| Example 28 | MGLN | 1 | SN | 2 | HTCN | 1 | — | — |
| Example 29 | MGLN | 1 | SN | 2 | HTCN | 1 | — | — |
| Example 30 | MGLN | 1 | SN | 2 | HTCN | 1 | — | — |
| Example 31 | MGLN | 1 | SN | 2 | HTCN | 1 | — | — |
| Example 32 | MGLN | 1 | SN | 2 | HTCN | 1 | — | — |
| Example 33 | MGLN | 1 | SN | 2 | HTCN | 1 | — | — |
| Example 34 | MGLN | 1 | SN | 2 | HTCN | 1 | II-1 | 3 |
| Example 35 | MGLN | 1 | SN | 2 | HTCN | 1 | II-1 | 3 |
| Example 36 | MGLN | 1 | SN | 2 | HTCN | 1 | — | — |
| Example 37 | MGLN | 1 | SN | 2 | HTCN | 1 | II-1 | 3 |

| | | | Boron- | | | | |
|---|---|---|---|---|---|---|---|
| | | | containing | | | | |
| | | | lithium salt | | | | |
| | Compound IV | | | Percentage | | High-temperature | Cycling |
| | | Percentage | | M | | storage thickness | impedance |
| | Compound | (wt %) | Compound | (wt %) | M/X | [symbol] | growth rate |
| Example 1 | — | — | — | — | — | 15.2% | 29.7% |
| Example 16 | — | — | — | — | — | 15.1% | 29.6% |
| Example 17 | — | — | — | — | — | 14.3% | 29.0% |
| Example 18 | — | — | — | — | — | 11.5% | 27.5% |
| Example 19 | — | — | — | — | — | 10.9% | 26.7% |
| Example 20 | — | — | — | — | — | 10.0% | 29.2% |
| Example 21 | — | — | — | — | — | 10.0% | 29.5% |
| Example 22 | — | — | — | — | — | 9.7% | 26.5% |
| Example 23 | POTPN | 0.01 | — | — | — | 15.1% | 29.7% |
| Example 24 | POTPN | 0.1 | — | — | — | 13.8% | 29.3% |
| Example 25 | POTPN | 0.5 | — | — | — | 12.4% | 28.5% |
| Example 26 | POTPN | 1 | — | — | — | 11.2% | 27.2% |
| Example 27 | POTPN | 2 | — | — | — | 8.6% | 26.6% |
| Example 28 | POTPN | 2.2 | — | — | — | 8.7% | 26.7% |
| Example 29 | — | — | LiBOB | 0.1 | 0.1 | 15.5% | 29.1% |
| Example 30 | — | — | LiBOB | 0.5 | 0.5 | 16.2% | 27.2% |
| Example 31 | — | — | LiBOB | 0.7 | 0.7 | 17.9% | 26.0% |
| Example 32 | — | — | LiBOB | 1 | 1 | 23.2% | 25.5% |
| Example 33 | — | — | LiBOB | 1.2 | 1.2 | 27.7% | 25.2% |
| Example 34 | POTPN | 0.5 | — | — | — | 7.8% | 26.2% |
| Example 35 | — | — | LiBOB | 0.5 | 0.5 | 13.0% | 24.6% |
| Example 36 | POTPN | 0.5 | LiBOB | 0.5 | 0.5 | 12.6% | 25.1% |
| Example 37 | POTPN | 0.5 | LiBOB | 0.5 | 0.5 | 8.3% | 23.5% |

[symbol]

indicates data missing or illegible when filed

On the basis that the electrolyte contains 0.12% to 5.0% of the compound of Formula I-A, 0.12% to 5.0% of the compound of Formula I-B, and 0.12% to 3.0% of the compound of Formula I-C, adding 0.01% to 10% of the compound containing a sulfur-oxygen double bond, the compound IV, and/or 0.01% to 1% of the boron-containing lithium salt to the electrolyte can further reduce the cycling impedance growth rate and/or high-temperature storage thickness swelling rate of the lithium-ion battery.

When the percentage of the compound IV in the electrolyte ranges from 0.01% to 2%, the cycling impedance growth rate and high-temperature storage voltage drop of the lithium-ion battery are further optimized.

When the percentage (M %) of the boron-containing lithium salt and the percentage (X %) of the compound of Formula I-A in the electrolyte satisfy M/X not greater than 1, the cycling impedance growth rate and/or high-temperature storage thickness swelling rate of the lithium-ion battery can be further reduced.

Table 3 shows the influence of the compound of Formula III and its percentage in the electrolyte on the cycling performance of the lithium-ion battery.

TABLE 3

| | Compound of | | Compound of | | Compound of | | | | |
|---|---|---|---|---|---|---|---|---|---|
| | Formula I-A | | Formula I-B | | Formula I-C | | Compound of | | Cycling |
| | | Percentage | | Percentage | | Percentage | Formula III | | capacity |
| | | X | | Y | | Z | | Percentage | retention |
| | Compound | (wt %) | Compound | (wt %) | Compound | (wt %) | Compound | (wt %) | rate |
| Example 1 | MGLN | 1 | SN | 2 | HTCN | 1 | — | — | 72.5% |
| Example 38 | MGLN | 1 | SN | 2 | HTCN | 1 | III-1 | 0.1 | 73.2% |
| Example 39 | MGLN | 1 | SN | 2 | HTCN | 1 | III-1 | 5 | 75.6% |
| Example 40 | MGLN | 1 | SN | 2 | HTCN | 1 | III-1 | 10 | 79.8% |
| Example 41 | MGLN | 1 | SN | 2 | HTCN | 1 | III-1 | 15 | 80.6% |
| Example 42 | MGLN | 1 | SN | 2 | HTCN | 1 | III-1 | 30 | 81.9% |
| Example 43 | EHDN | 1 | SN | 2 | HTCN | 1 | III-1 | 5 | 80.5% |
| Example 44 | MGLN | 1 | SN | 2 | HTCN | 1 | III-1 | 5 | 82.3% |
| | | | | | | | III-2 | 1 | |

On the basis that the electrolyte contains 0.12% to 5.0% of the compound of Formula I-A, 0.12% to 5.0% of the compound of Formula I-B, and 0.12% to 3.0% of the compound of Formula I-C, adding 0.01% to 15% of the compound of Formula III to the electrolyte can further improve the cycling capacity retention rate of the lithium-ion battery.

In the specification, reference to “an embodiment”, “some embodiments”, “one embodiment”, “another example”, “an example”, “a specific example”, or “some examples” means that at least one embodiment or example in this application includes a specific feature, structure, material, or characteristic described in this embodiment or example. Therefore, descriptions in various places throughout this specification, such as “in some embodiments”, “in these embodiments”, “in an embodiment”, “in another example”, “in an example”, “in a specified example”, or “examples” do not necessarily refer to the same embodiment or example in this application. In addition, specific features, structures, materials, or characteristics herein may be combined in any appropriate manner in one or more embodiments or examples.

Although illustrative embodiments have been demonstrated and described, persons skilled in the art should understand that the foregoing embodiments cannot be construed as limitations on this application, and that these embodiments may be changed, replaced, and modified without departing from the spirit, principle, and scope of this application.

What is claimed is:

1. An electrolyte, comprising a compound of Formula I-A, a compound of Formula I-B, and a compound of Formula I-C: 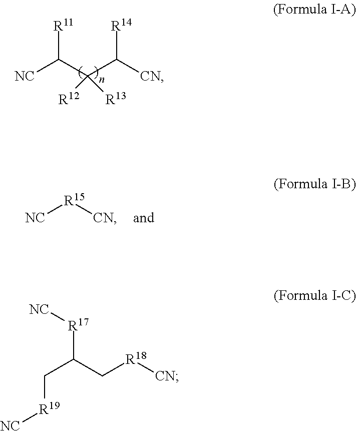
wherein
n is an integer selected from 1 to 8;
R¹¹, R¹², R¹³, and R¹⁴ are each independently selected from hydrogen, halogen, or a substituted or unsubstituted C₁-C₅ alkyl group, and at least one of R¹¹, R¹², R¹³, or R¹⁴ is a substituted or unsubstituted C₁-C₅ alkyl group;
R¹⁵ is selected from a C₂-C₄ alkylene group, a C₂-C₄ alkenylene group, 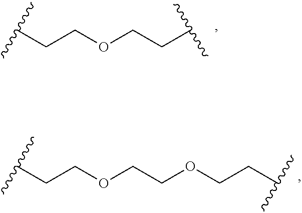 [SMILES: *CCOCC* ; *CCOCCOCC*]
R¹⁷, R¹⁸, and R¹⁹ are each independently selected from a single bond, a C₁-C₅ alkylene group, or a C₁-C₅ alkoxyalkylene group;
when substitution is performed, substituents are each independently halogen; 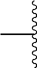
represents a connection site of two adjacent atoms; and
based on a mass of the electrolyte,
a percentage of the compound of Formula I-A is X %, X is in a range of 0.12 to 5.0,
a percentage of the compound of Formula I-B is Y %, Y is in a range of 0.12 to 5.0, and
a percentage of the compound of Formula I-C is Z %, Z is in a range of 0.12 to 3.0.

2. The electrolyte according to claim 1, wherein
X is in a range of 0.5 to 4.2;
Y is in a range of 0.5 to 4.2; and
Z is in a range of 0.5 to 3.0.

3. The electrolyte according to claim 1, wherein Z/X is in a range of 0.1 to 3.

4. The electrolyte according to claim 3, wherein Z/X is in a range of 0.6 to 2.5.

5. The electrolyte according to claim 1, wherein the compound of Formula I-A comprises at least one of the following compounds:

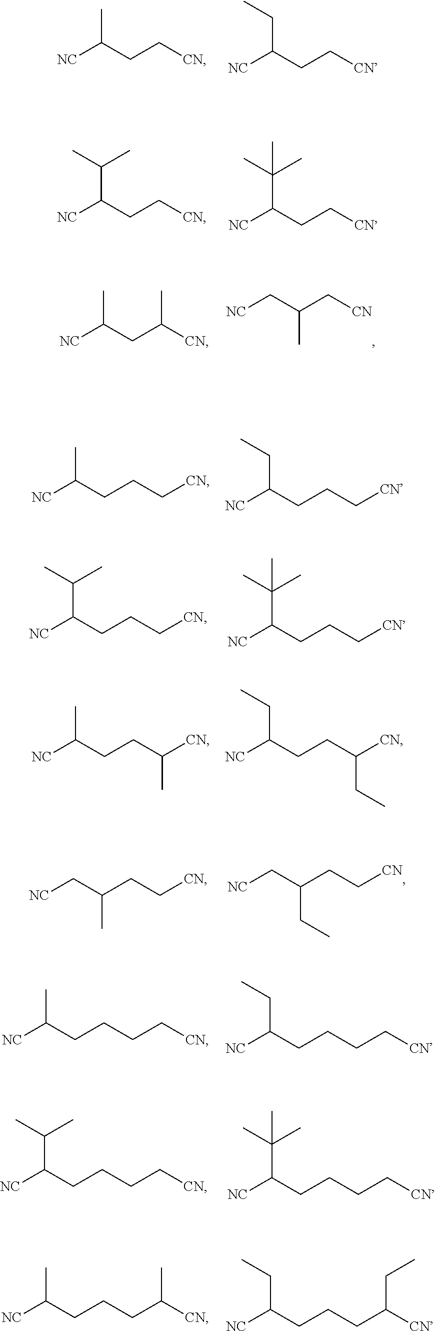

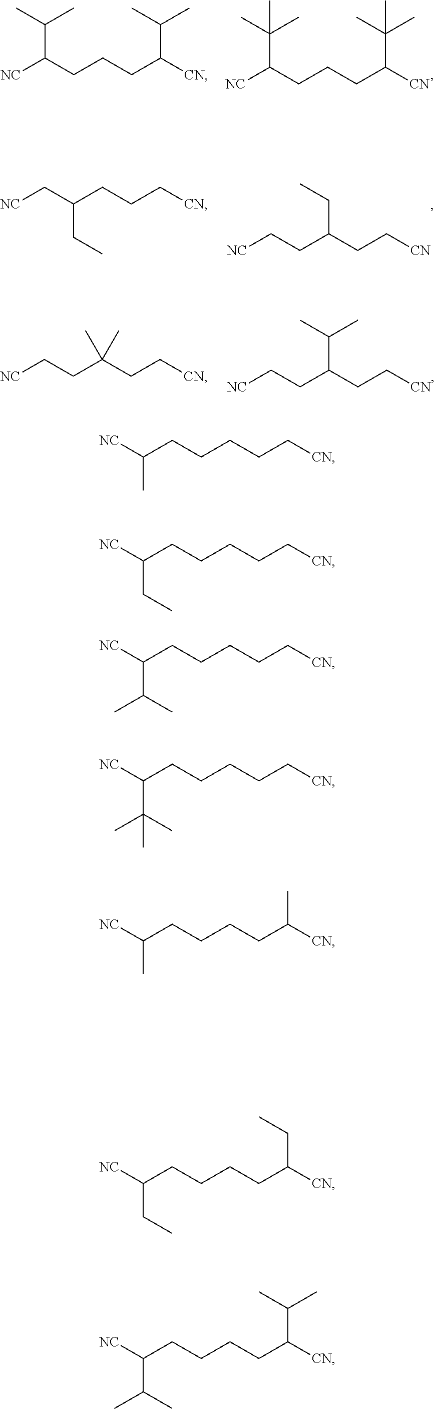

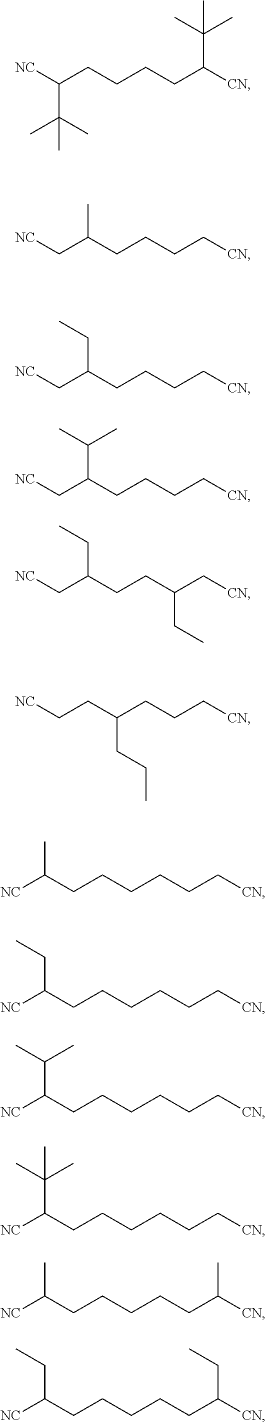

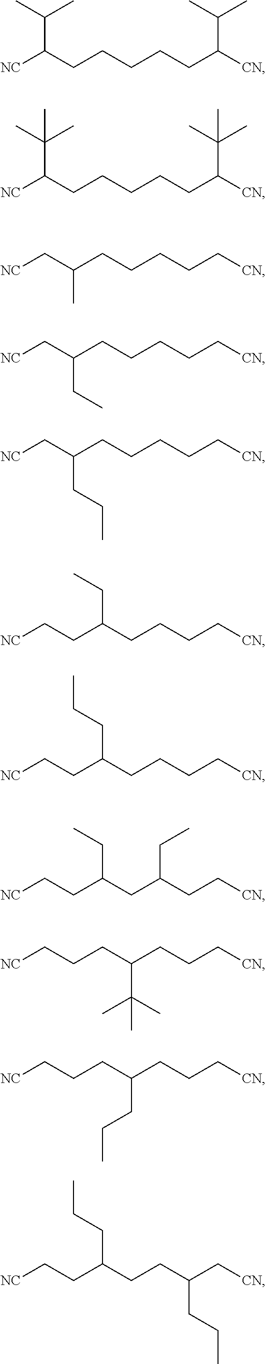

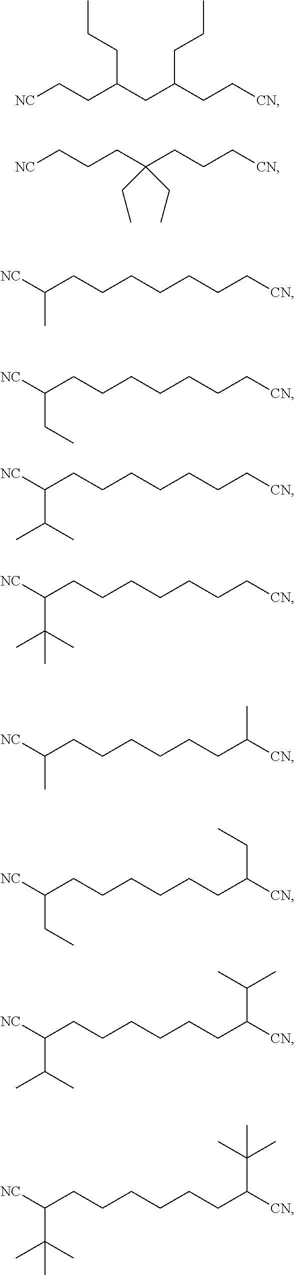

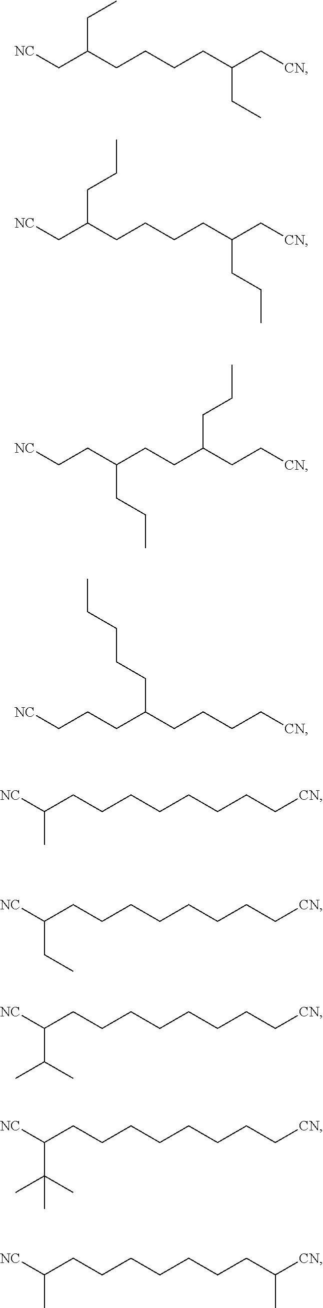

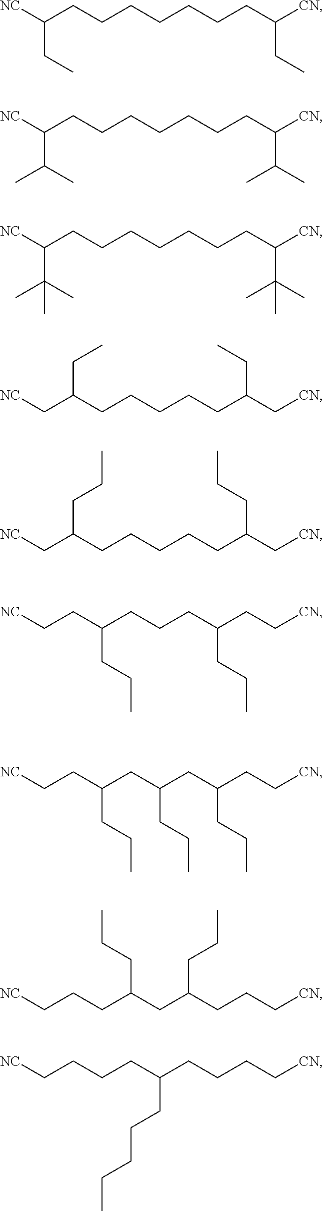

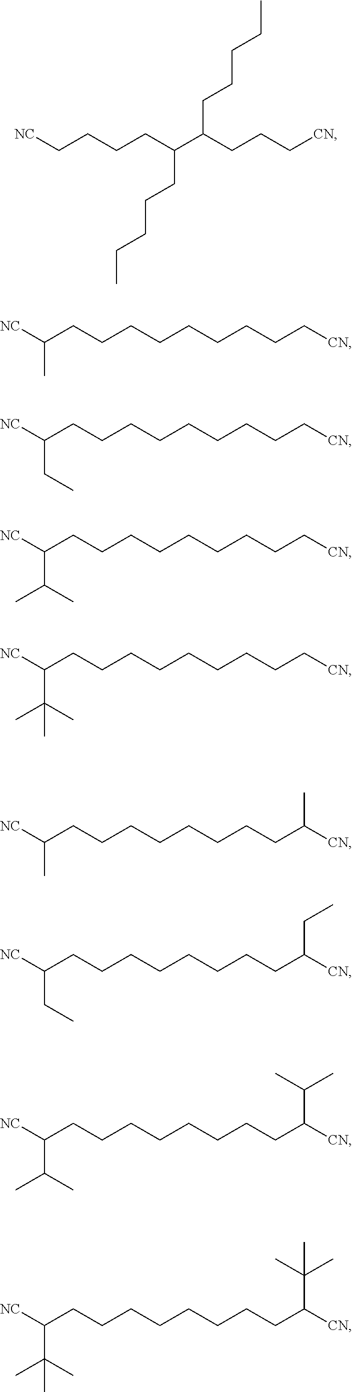

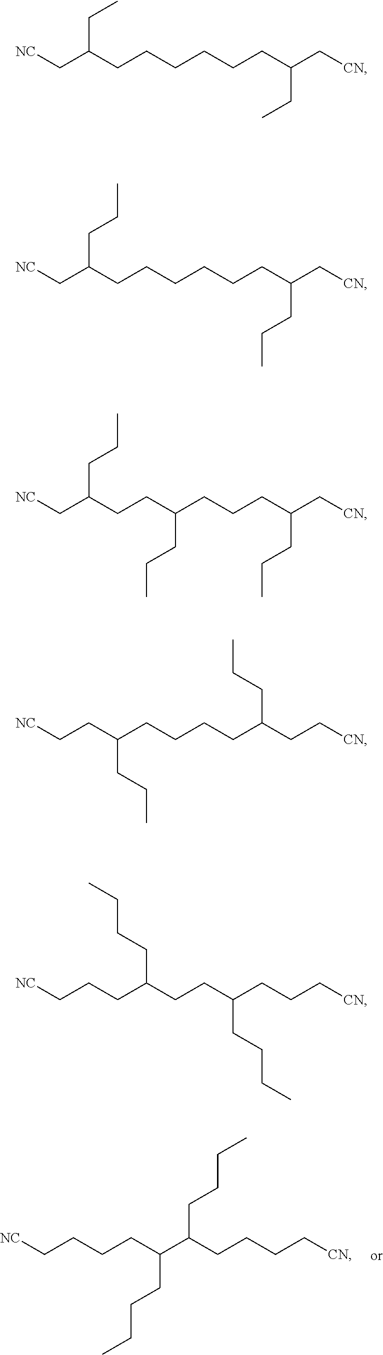 [SMILES: CCC(CC#N)CCCCCCC(CC)CC#N ; CCCC(CC#N)CCCCCCC(CC#N)CCC ; CCCC(CC#N)CCCC(CCC)CCC(CC#N)CCC ; CCCC(CCC#N)CCCCC(CCC)CCC#N ; CCCCC(CCCC#N)CCC(CCCC)CCCC#N ; CCCCC(CCCCC#N)C(CCCC)CCCCC#N]

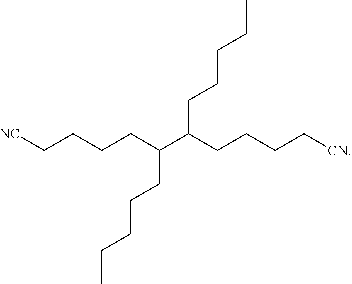 [SMILES: CCCCCC(CCCCC#N)C(CCCCC)CCCCC#N]

6. The electrolyte according to claim 1, wherein the compound of Formula I-B comprises at least one of the following compounds:

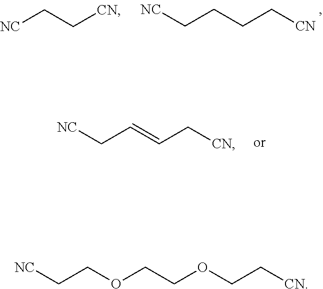 [SMILES: N#CCCC#N ; N#CCCCCC#N ; N#CC/C=C/CC#N ; "or" ; N#CCCOCCOCCC#N]

7. The electrolyte according to claim 1, wherein the compound of Formula I-C comprises at least one of the following compounds:

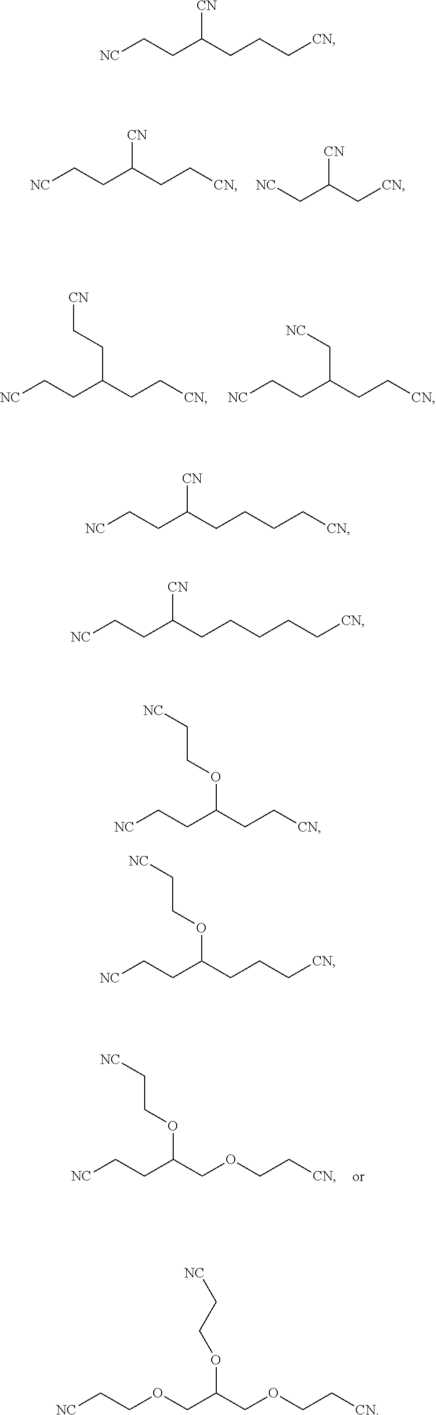

8. The electrolyte according to claim 1, wherein Y/X is in a range of 0.12 to 5.

9. The electrolyte according to claim 1, wherein the electrolyte further comprises a compound containing a sulfur-oxygen double bond; and based on the mass of the electrolyte, a percentage of the compound containing a sulfur-oxygen double bond is 0.01% to 10%.

10. The electrolyte according to claim 9, wherein the compound containing a sulfur-oxygen double bond comprises a compound of Formula II: 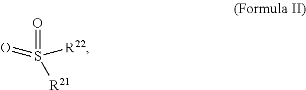
wherein
R²¹ and R²² are each independently selected from a substituted or unsubstituted C₁-C₅ alkyl group, a substituted or unsubstituted C₂-C₁₀ alkenyl group, a substituted or unsubstituted C₂-C₁₀ alkynyl group, a substituted or unsubstituted C₃-C₁₀ alicyclic group, a substituted or unsubstituted C₆-C₁₀ aryl group, or a substituted or unsubstituted C₁-C₅ heteroatom functional group, with a heteroatom in the heteroatom functional group selected from at least one of O or S;
R²¹ and R²² are optionally connected to form a ring; and
when substitution is performed, substituents are each independently selected from halogen.

11. The electrolyte according to claim 9, wherein the compound containing a sulfur-oxygen double bond comprises at least one of the following compounds:

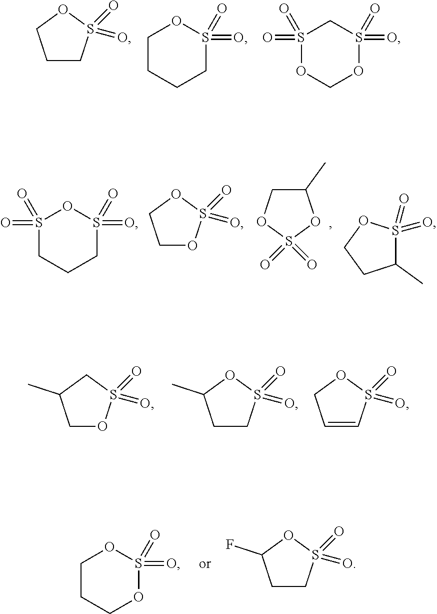

12. The electrolyte according to claim 1, wherein the electrolyte further comprises a compound of Formula III: 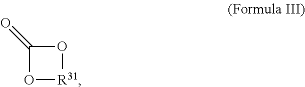
wherein
R³¹ is selected from a substituted or unsubstituted C₁-C₆ alkylene group or a substituted or unsubstituted C₂-C₆ alkenylene group;
when substitution is performed, substituents are each independently selected from halogen, a C₁-C₆ alkyl group, or a C₂-C₆ alkenyl group; and
based on the mass of the electrolyte, a percentage of the compound of Formula III is 0.01% to 15%.

13. The electrolyte according to claim 12, wherein the compound of Formula III comprises at least one of the following compounds:

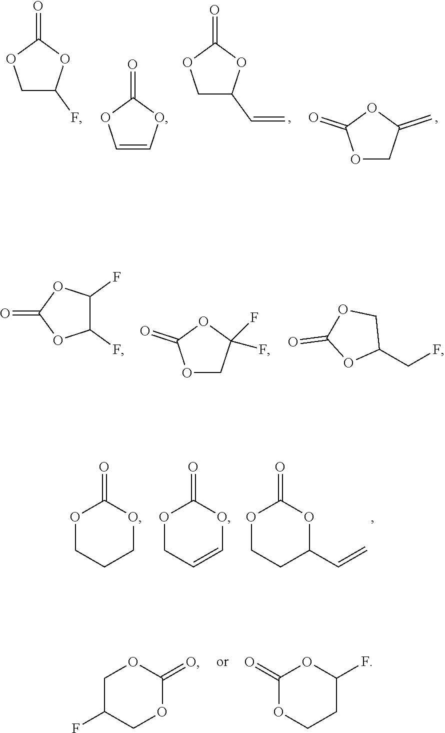

14. The electrolyte according to claim 1, wherein the electrolyte further comprises a compound IV, and the compound IV comprises at least one of the following compounds:

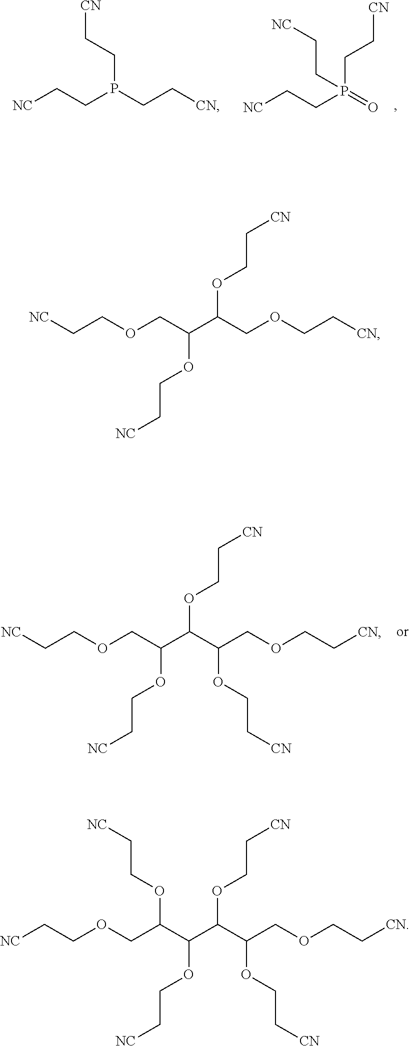 [SMILES: N#CCCP(CCC#N)CCC#N ; N#CCCP(=O)(CCC#N)CCC#N ; N#CCCOCC(OCCC#N)C(COCCC#N)OCCC#N ; N#CCCOCC(OCCC#N)C(OCCC#N)C(COCCC#N)OCCC#N ; N#CCCOCC(OCCC#N)C(OCCC#N)C(OCCC#N)C(COCCC#N)OCCC#N]

15. The electrolyte according to claim 14, wherein based on the mass of the electrolyte, a percentage of the compound IV is 0.01% to 2%.

16. The electrolyte according to claim 1, wherein the electrolyte further comprises a boron-containing lithium salt; and based on the mass of the electrolyte, a percentage of the boron-containing lithium salt is 0.01% to 1%.

17. The electrolyte according to claim 16, wherein the boron-containing lithium salt comprises at least one of lithium tetrafluoroborate, lithium bis(oxalate)borate, or lithium difluoro(oxalate)borate.

18. The electrolyte according to claim 16, wherein based on the mass of the electrolyte, the percentage of the boron-containing lithium salt is M %, and M/X is not greater than 1.

19. An electrochemical apparatus, comprising an electrolyte; the electrolyte comprises a compound of Formula I-A, a compound of Formula I-B, and a compound of Formula I-C: 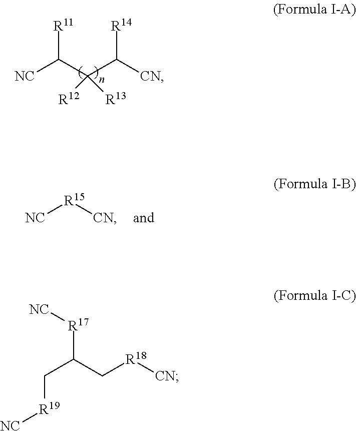
wherein
n is an integer selected from 1 to 8;
R¹¹, R¹², R¹³, and R¹⁴ are each independently selected from hydrogen, halogen, or a substituted or unsubstituted C₁-C₅ alkyl group, and at least one of R¹¹, R¹², R¹³, or R¹⁴ is a substituted or unsubstituted C₁-C₅ alkyl group;
R¹⁵ is selected from a C₂-C₄ alkylene group, a C₂-C₄ alkenylene group, 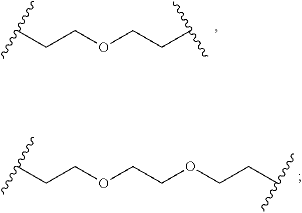 [SMILES: *CCOCC* ; *CCOCCOCC*]
R¹⁷, R¹⁸, and R¹⁹ are each independently selected from a single bond, a C₁-C₅ alkylene group, or a C₁-C₅ alkoxyalkylene group;
when substitution is performed, substituents are each independently halogen; 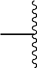
represents a connection site of two adjacent atoms; and
based on a mass of the electrolyte,
a percentage of the compound of Formula I-A is X %, X is in a range of 0.12 to 5.0,
a percentage of the compound of Formula I-B is Y %, Y is in a range of 0.12 to 5.0, and
a percentage of the compound of Formula I-C is Z %, Z is in a range of 0.12 to 3.0.

20. The electrochemical apparatus according to claim 19, wherein
X is in a range of 0.5 to 4.2;
Y is in a range of 0.5 to 4.2; and
Z is in a range of 0.5 to 3.0.
